(19) United States
(12) Patent Application Publication
(10) Pub. No.: US 2024/0009566 A1
(43) Pub. Date: Jan. 11, 2024

(54) VIRTUAL PROP TRANSFER METHOD AND APPARATUS, TERMINAL, STORAGE MEDIUM, AND PROGRAM PRODUCT

(71) Applicant: Tencent Technology (Shenzhen) Company Limited, Shenzhen (CN)

(72) Inventor: Ziyi WANG, Shenzhen (CN)

(21) Appl. No.: 18/371,974

(22) Filed: Sep. 22, 2023

Related U.S. Application Data
(63) Continuation of application No. PCT/CN2022/138075, filed on Dec. 9, 2022.

(30) Foreign Application Priority Data
Mar. 25, 2022 (CN) 202210307698.6

(51) Int. Cl. A63F 13/537; A63F 13/837; A63F 13/52; A63F 13/533

(52) U.S. Cl. CPC A63F 13/537; A63F 13/837; A63F 13/52; A63F 13/533

(57) ABSTRACT

Disclosed is a virtual prop transfer method performed by a computer device. The method includes: displaying a battle picture, the battle picture including a first virtual object; determining that the first virtual object has a prop obtaining request followed by an aiming crosshair of a second virtual object pointing to the first virtual object, the first virtual object and the second virtual object belonging to a same camp; displaying a prop transfer control in response to the aiming crosshair of the second virtual object pointing to the first virtual object; and in response to a trigger operation on the prop transfer control, controlling the second virtual object to transfer a virtual prop to the first virtual object according to the prop obtaining request. This method can improve efficiency of transferring virtual props.

### CROSS-REFERENCE TO RELATED APPLICATIONS

This application is a continuation application of PCT Patent Application No. PCT/CN2022/138075, entitled “VIRTUAL PROP TRANSFER METHOD AND APPARATUS, TERMINAL, STORAGE MEDIUM, AND PROGRAM PRODUCT” filed on Dec. 9, 2022, which claims priority to Chinese Patent Application No. 202210307698.6, entitled “VIRTUAL PROP TRANSFER METHOD AND APPARATUS, TERMINAL, STORAGE MEDIUM, AND PROGRAM PRODUCT” filed on Mar. 25, 2022, all of which is incorporated herein by reference in its entirety.

### FIELD OF THE TECHNOLOGY

Embodiments of this application relate to the field of human-computer interaction technologies, and in particular, to a virtual prop transfer method and apparatus, a terminal, a storage medium, and a program product.

### BACKGROUND OF THE DISCLOSURE

A first person shooting (FPS) game is an application based on a three-dimensional virtual environment, a user may operate a virtual object in a virtual environment to perform motions such as walking, running, climbing, and shooting, and a plurality of users may team up online to complete a task in the same virtual environment.

In the related art, members of the same team often need to exchange materials due to lack of materials or a need for material allocation during a battle. A complete material exchange process is as follows: A material provider needs to open a backpack, select exchange materials, discard and mark the materials, and a corresponding material receiver needs to pick up the materials at a designated place.

Obviously, the material exchange process during the battle in the related art is relatively cumbersome.

### SUMMARY

Embodiments of this application provide a virtual prop transfer method and apparatus, a terminal, a storage medium, and a program product. The technical solutions are as follows:

According to an aspect, an embodiment of this application provides a virtual prop transfer method, performed by a computer device (e.g., a terminal), the method including:
displaying a battle picture, the battle picture including a first virtual object;
determining that the first virtual object has a prop obtaining request followed by an aiming crosshair of a second virtual object pointing to the first virtual object, the first virtual object and the second virtual object belonging to a same camp;
displaying a prop transfer control in response to the aiming crosshair of the second virtual object pointing to the first virtual object; and
in response to a trigger operation on the prop transfer control, controlling the second virtual object to transfer a virtual prop to the first virtual object according to the prop obtaining request.
According to another aspect, an embodiment of this application provides a virtual prop transfer method, performed by a terminal, the method further including:
displaying a prop obtaining control, the prop obtaining control being configured to trigger a first virtual object to request a second virtual object to transfer a virtual prop, and the first virtual object and the second virtual object belonging to a same camp;
determining a first virtual prop in response to a trigger operation on a sub-control in the prop obtaining control, the sub-control being configured to indicate the first virtual prop that the first virtual object requests to obtain;
displaying a prop identifier of the first virtual prop around the first virtual object, the prop identifier being used for representing that the first virtual object has a prop obtaining request; and
receiving the first virtual prop transferred by the second virtual object to the first virtual object, the second virtual object triggering, by using the prop transfer control, transfer of the first virtual prop, and the prop transfer control being configured to be displayed when an aiming crosshair of the second virtual object points to the first virtual object.

According to another aspect, an embodiment of this application provides a computer device, including a processor and a memory, the memory storing at least one program, the at least one program being loaded and executed by the processor and causing the computer device to implement the virtual prop transfer methods described above.

According to another aspect, an embodiment of this application provides a non-transitory computer-readable storage medium, storing at least one program, the at least one program being loaded and executed by a processor of a computer device and causing the computer device to implement the virtual prop transfer methods described above.

The technical solutions provided in the embodiments of this application have at least the following beneficial effects:

A method for transferring virtual props between virtual objects in a battle is provided. When a first virtual object has a prop obtaining request for a virtual prop, second virtual objects belonging to a same camp may aim at the first virtual object, and click a prop transfer control, so that the virtual prop is transferred to the first virtual object. Compared with the related art that requires several steps such as opening a backpack, selecting exchange materials, discarding and marking materials, and picking up materials, the virtual prop transfer method provided in this application can greatly simplify operation steps of transferring virtual props and reduce operation costs for virtual prop transfer, thereby improving efficiency of transferring the virtual props. In addition, a virtual prop giver (virtual prop transfer party) can realize one-click transfer of virtual props by triggering a prop transfer control, so that prop giving costs of the virtual prop giver may be reduced, thereby improving frequency of using a virtual prop transfer function in a battle while promoting more users to control virtual objects to become virtual prop givers and enhancing communication with teammates.

### BRIEF DESCRIPTION OF THE DRAWINGS

FIG. 1 is a schematic diagram of an implementation environment according to an embodiment of this application.

FIG. 2 is a flowchart of a virtual prop transfer method according to an exemplary embodiment of this application.

FIG. 3 is a schematic diagram of a virtual prop transfer process according to an exemplary embodiment of this application.

FIG. 4 is a flowchart of a virtual prop transfer method according to another exemplary embodiment of this application.

FIG. 5 is a schematic diagram of a virtual prop transfer process according to another exemplary embodiment of this application.

FIG. 6 is a flowchart of a virtual prop transfer method according to another exemplary embodiment of this application.

FIG. 7 is a schematic diagram of performing an editing operation on a prop transfer control according to an exemplary embodiment of this application.

FIG. 8 is a flowchart of performing virtual prop transfer by a virtual prop giver according to an exemplary embodiment of this application.

FIG. 9 is a flowchart of a virtual prop transfer method according to another exemplary embodiment of this application.

FIG. 10 is a schematic diagram of a process of initiating a prop obtaining request according to an exemplary embodiment of this application.

FIG. 11 is a schematic diagram of a process of selecting a virtual prop according to an exemplary embodiment of this application.

FIG. 12 is a flowchart of performing virtual prop transfer by a person lacking virtual props according to an exemplary embodiment of this application.

FIG. 13 is a structural block diagram of virtual prop transfer apparatus according to an exemplary embodiment of this application.

FIG. 14 is a structural block diagram of virtual prop transfer apparatus according to another exemplary embodiment of this application.

FIG. 15 is a structural block diagram of a terminal according to an exemplary embodiment of this application.

### DESCRIPTION OF EMBODIMENTS

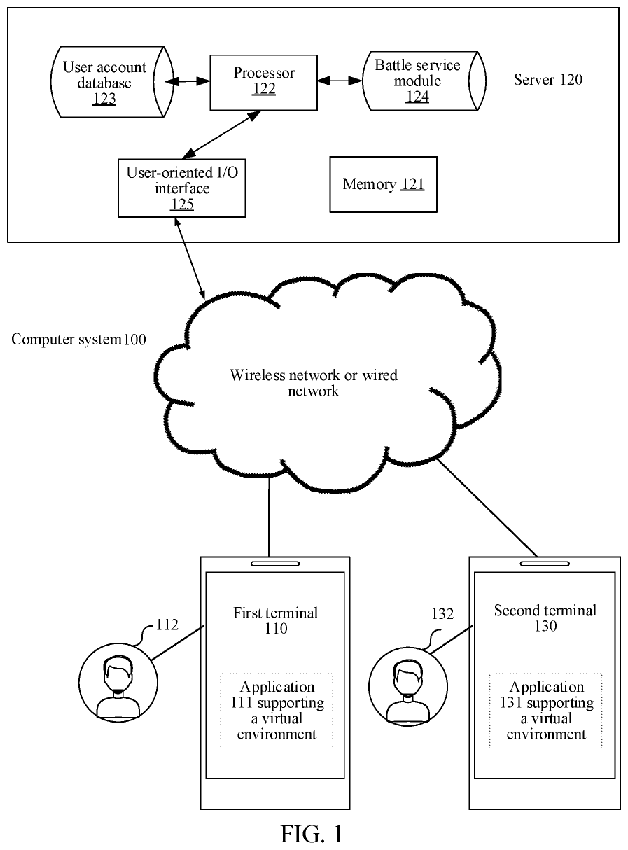

FIG. 1 is a schematic diagram of an implementation environment according to an embodiment of this application. The implementation environment may include: a first terminal 110, a server 120, and a second terminal 130.

An application 111 supporting a virtual environment is run on the first terminal 110, and the application 111 may be a multiplayer online battle program. When the first terminal runs the application 111, a user interface of the application 111 is displayed on a screen of the first terminal 110. The application 111 may be any one of a multiplayer online battle arena (MOBA) game and a simulation game (SLG). In this embodiment, the description is made by using an example in which the application 111 is a first-person shooting (FPS) game. The first terminal 110 is a terminal used by a first user 112. The first user 112 uses the first terminal 110 to control a first virtual object located in the virtual environment to perform activities, and the first virtual object may be referred to as a main control virtual object of the first user 112. The activities of the first virtual object include, but are not limited to: at least one of adjusting body postures, crawling, walking, running, riding, flying, jumping, driving, picking, shooting, attacking, throwing, and skill casting. For example, the first virtual object is a first virtual person such as a simulated person or a cartoon person.

An application 131 supporting a virtual environment is run on the second terminal 130, and the application 131 may be a multiplayer online battle program. When the second terminal 130 runs the application 131, a user interface of the application 131 is displayed on a screen of the second terminal 130. The client may be any one of a MOBA game and an SLG game. In this embodiment, description is made below by using an example in which the application 131 is an FPS game. The second terminal 130 is a terminal used by a second user 132. The second user 132 uses the second terminal 130 to control a second virtual object located in the virtual environment to perform activities, and the second virtual object may be referred to as a main control virtual object of the second user 132. For example, the second virtual object is a second virtual person, such as a simulated person or a cartoon person.

In some embodiments, the first virtual object and the second virtual object are located in the same virtual world. In some embodiments, the first virtual object and the second virtual object may belong to the same camp, the same team, or the same organization, have a friend relationship with each other, or have a temporary communication permission. In some embodiments, the first virtual object and the second virtual object may belong to different camps, different teams, or different organizations, or have a hostile relationship with each other.

In some embodiments, the application installed on the first terminal 110 is same as the application installed on the second terminal 130, or the applications installed on the two terminals are applications of a same type on different operating system platforms (such as Android or IOS). The first terminal 110 may generally refer to one of a plurality of terminals, and the second terminal 130 may generally refer to another one of a plurality of terminals. In this embodiment, only the first terminal 110 and the second terminal 130 are used as an example for description. Device types of the first terminal 110 and the second terminal 130 are the same or different. The device type includes at least one of a smartphone, a tablet computer, an e-book reader, a Moving Picture Experts Group Audio Layer III (MP3) player, a Moving Picture Experts Group Audio Layer IV (MP4) player, a laptop computer, and a desktop computer.

FIG. 1 shows only two terminals. However, a plurality of other terminals may access the server 120 in different embodiments. In some embodiments, one or more terminals are terminals corresponding to a developer. A developing and editing platform for the application supporting a virtual environment is installed on the terminal. The developer may edit and update the application on the terminal and transmit an updated application installation package to the server 120 by using a wired or wireless network. The first terminal 110 and the second terminal 130 may download the application installation package from the server 120 to update the application.

The first terminal 110, the second terminal 130, and the other terminals are connected to the server 120 through a wireless or wired network.

The server 120 includes at least one of one server, a server cluster including a plurality of servers, a cloud computing platform, and a virtualization center. The server 120 is configured to provide a backend service for an application supporting a three-dimensional virtual environment. In some embodiments, the server 120 is responsible for primary computing work, and the terminal is responsible for secondary computing work; or the server 120 is responsible for secondary computing work, and the terminal is responsible for primary computing work; or the server 120 and the terminal perform collaborative computing by using a distributed computing architecture between each other.

In a schematic example, the server 120 includes a memory 121, a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the another terminal, for example, avatars of the user accounts, nicknames of the user accounts, battle effectiveness indexes of the user accounts, and service zones of the user accounts. The battle service module 124 is configured to provide a plurality of battle rooms for the users to battle, for example, a 1V1 battle room, a 3V3 battle room, a 5V5 battle room, and the like. The user-oriented I/O interface 125 is configured to establish communication between the first terminal 110 and/or the second terminal 130 by using a wireless network or a wired network for data exchange.

A virtual bullet, virtual medicine, a medical kit, energy drinks, a bandage, and the like in the embodiments of this application are virtual props in the game.

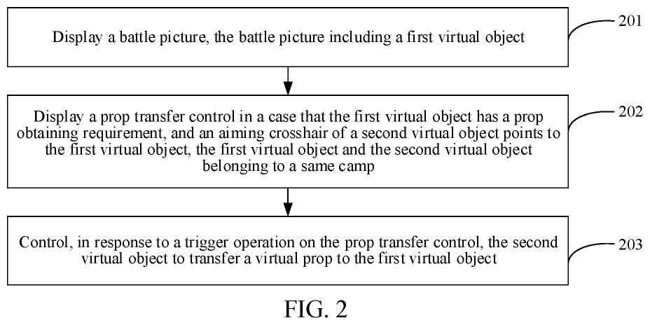

FIG. 2 is a flowchart of a virtual prop transfer method according to an exemplary embodiment of this application. This embodiment is described by using an example in which the method is applied to the first terminal 110 or the second terminal 130 in the implementation environment shown in FIG. 1 or another terminal in the implementation environment. The method includes the following steps.

Step 201: Display a battle picture, the battle picture including a first virtual object.

In a possible implementation, after a user controls a second virtual object to enter a battle, the user may control, by using a terminal, the second virtual object to move in a virtual environment, and the corresponding terminal may display a battle picture from a corresponding perspective of the second virtual object.

In some embodiments, the battle picture may be a picture obtained by observing a virtual environment in a first-person perspective. In the first-person perspective, the second virtual object controlled by the user is not displayed in the battle picture. Alternatively, a first battle picture may be a picture obtained by observing a virtual environment in a third-person perspective. In the third-person perspective, the second virtual object controlled by the user is displayed in the battle picture.

In some embodiments, in the embodiments of this application, the perspective is an angle for observing the virtual object by using a camera model in the virtual environment. When the first-person perspective is used, the camera model is located near the head of the virtual object or at the head of the virtual object. When the third-person perspective is used, the camera model may be located behind the virtual object and bound to the virtual object, or may be located at any position away from the virtual object by a preset distance. The virtual object located in the virtual environment may be observed from different angles through the camera model. In some embodiments, when the third-person perspective is a first-person over-shoulder perspective, the camera model is located behind the virtual object (for example, the head and the shoulders of a virtual person). In some embodiments, in addition to the first-person perspective and the third-person perspective, the perspective further includes another perspective such as a look-down perspective. When the look-down perspective is used, the camera model may be located above the head of the virtual object. The look-down perspective is a perspective for observing the virtual environment at an angle from the air. In some embodiments, the camera model is not actually displayed in the virtual environment. In other words, the camera model is not displayed in the virtual environment displayed in the user interface.

In some embodiments, in addition to the virtual objects, a virtual environment may further be displayed in the battle picture. The virtual environment includes at least one of the following elements: a mountain, a plain, a river, a lake, a sea, a desert, sky, a plant, a building, and a vehicle. In some embodiments, if there is another virtual object within a field of view of the second virtual object, the another virtual object may also be displayed in the battle picture.

In this embodiment, during virtual prop transfer, a first virtual object (which is a virtual object having a prop obtaining request) needs to exist within a field of view of a virtual object mastered by the user (the second virtual object) the user, so that virtual prop transfer may be triggered to be performed on the first virtual object when the first virtual object can be aimed. In other words, in a prop transfer scenario shown in this embodiment of this application, the battle picture includes at least the first virtual object having the prop obtaining request, and the first virtual object and a second virtual object that is mastered by the terminal belong to a same camp.

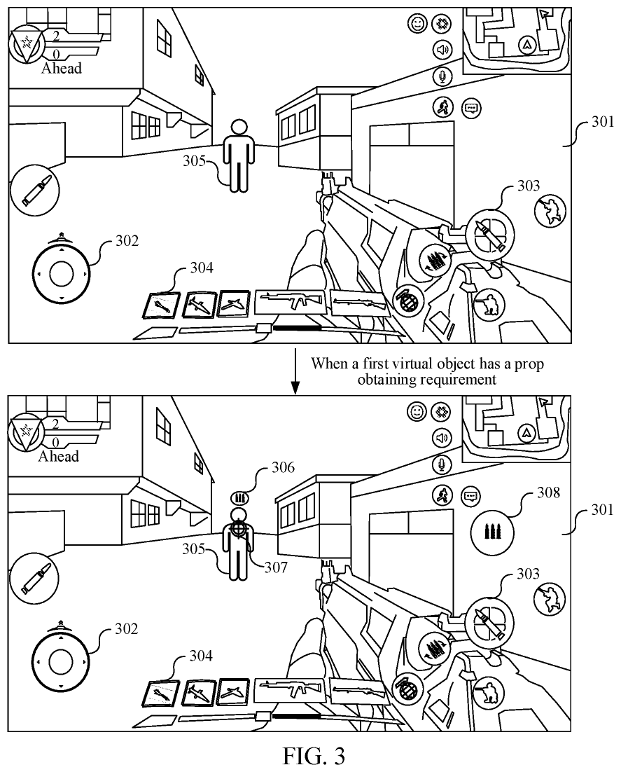

FIG. 3 is a schematic diagram of a virtual prop transfer process according to an exemplary embodiment of this application. After the user controls the second virtual object to enter a battle, a battle picture 301 (where the battle picture 301 is a battle picture in a first-person perspective) is displayed. In some embodiments, a movement control 302, a damage control 303, a prop bar 304, and the like are further displayed on the battle picture 301. The movement control 302 is configured to control the second virtual object to move toward a direction in the virtual environment. The damage control 303 is configured to control the second virtual object to perform a damage operation. The prop bar 304 is configured to switch a virtual prop currently held by the second virtual object. In some embodiments, if there is a first virtual object 305 within the field of view of the second virtual object, the first virtual object 305 is also displayed in the battle picture 301.

Step 202: Display a prop transfer control when the first virtual object has a prop obtaining request, and an aiming crosshair of a second virtual object points to the first virtual object, the first virtual object and the second virtual object belonging to a same camp.

Different from the virtual prop transfer process in the related art, a virtual prop transfer party needs to discard a virtual prop, and then a virtual prop receiver picks up the virtual prop. In this embodiment, a prop transfer control is provided. After the prop transfer control is activated and displayed in a specific manner, an effect of one-click transfer of virtual props can be achieved by using the prop transfer control, thereby reducing operation process of both parties during the virtual prop transfer process, and improving efficiency of virtual prop transfer during the battle.

To enable the terminal to determine whether the second virtual object has a need to transfer virtual props to the first virtual object, in a possible implementation, when the first virtual object has a prop obtaining request, when the aiming crosshair of the second virtual object points to the first virtual object, it indicates that the user has a need to control the second virtual object to transfer virtual props to the first virtual object, that is, the prop transfer control may be displayed, so that the user may subsequently implement virtual prop transfer by triggering the prop transfer control.

In some embodiments, a manner for the user to determine whether the first virtual object has the prop obtaining request may include: displaying a specific mark around or near the first virtual object, where the specific mark is used for representing that the first virtual object has the prop obtaining request; or sending, by a user who masters the first virtual object, a voice message or a text message to another user through a chat channel, where the voice message or the text message indicates that the first virtual object has the prop obtaining request. This is not limited in the embodiments of this application.

In some embodiments, the aiming crosshair may be a crosshair corresponding to a virtual prop currently held by the second virtual object, and the virtual prop may be a virtual shooting prop with a crosshair or a virtual prop that can view a position of the virtual object.

As shown in FIG. 3, when the first virtual object has the prop obtaining request, and a prop identifier 306 is displayed around the first virtual object 305, it indicates that the first virtual object 305 has the prop obtaining request. When the user needs to transfer virtual props to the first virtual object 305, an aiming crosshair 307 may point to the first virtual object 305. Correspondingly, when the terminal determines that the aiming crosshair 307 points to the first virtual object 305, a prop transfer control 308 may be displayed in the battle picture 301.

In some embodiments, in other possible implementation, when the first virtual object has the prop obtaining request, and the aiming crosshair of the second virtual object points to the first virtual object, the prop transfer control is set from an inactive state to an active state, so that the user may trigger the prop transfer control to control the second virtual object to transfer virtual props to the first virtual object. The prop transfer control in the inactive state cannot be triggered.

Step 203: Control, in response to a trigger operation on the prop transfer control, the second virtual object to transfer a virtual prop to the first virtual object.

In a possible implementation, when determining to transfer virtual props to the first virtual object, the user may click the prop transfer control, and the corresponding terminal receives the trigger operation on the prop transfer control, to control the second virtual object to transfer the virtual prop to the first virtual object. After virtual prop transfer is completed, a prop quantity of virtual props owned by the second virtual object decreases, a prop quantity of virtual props owned by the first virtual object increases, and a quantity of increased props of the first virtual object is equal to a quantity of decreased props of the second virtual object.

As shown in FIG. 3, after the user clicks the prop transfer control 308, the corresponding terminal may control, after receiving the trigger operation on the prop transfer control 308, the second virtual object to transfer virtual props to the first virtual object 305. In some embodiments, since the first virtual object 305 receives the virtual props, display of the corresponding prop identifier 306 around or near the first virtual object 305 may be stopped, to represent that the first virtual object has received the virtual props and does not have the prop obtaining request for the time being.

In some embodiments, a process in which the terminal controls the second virtual object to transfer virtual props to the first virtual object may be executed by the terminal. After receiving the trigger operation on the prop transfer control, the terminal may reduce the prop quantity of virtual props owned by the second virtual object, and correspondingly, prop transfer response information is forwarded, by using a server, to the terminal that controls the first virtual object. After receiving the prop transfer response information, the corresponding terminal that masters the first virtual object may increase the prop quantity of virtual props owned by the first virtual object. In some embodiments, a specific process in which the terminal controls the second virtual object to transfer virtual props to the first virtual object may be jointly performed by the terminal and the server. After receiving the trigger operation on the prop transfer control, the terminal may send a prop transfer request to the server. The server verifies the prop transfer request, and feeds back verification success information to the terminal after verification is successful. After receiving the verification success information, the corresponding terminal reduces the prop quantity of virtual props owned by the second virtual object. In addition, prop transfer response information is sent to the terminal that masters the first virtual object. Correspondingly, after receiving the prop transfer response information, the terminal that masters the first virtual object increases the prop quantity of virtual props owned by the first virtual object.

Based on the above, in the embodiments of this application, a method for transferring virtual props between virtual objects in a battle is provided. When a first virtual object has a prop obtaining request for virtual props, second virtual objects belonging to a same camp may aim at the first virtual object, and click a prop transfer control, so that the virtual props are transferred to the first virtual object. Compared with the related art that requires several steps such as opening a backpack, selecting exchange materials, discarding and marking materials, and picking up materials, the virtual prop transfer method provided in this application can greatly simplify operation steps of transferring virtual props and reduce operation costs for virtual prop transfer, thereby improving efficiency of transferring the virtual props. In addition, a virtual prop giver (virtual prop transfer party) can realize one-click transfer of virtual props by triggering a prop transfer control, so that prop giving costs of the virtual prop giver may be reduced, thereby improving frequency of using a virtual prop transfer function in a battle while promoting more users to control virtual objects to become virtual prop givers and enhancing communication with teammates.

To further improve efficiency of transferring virtual props, in a possible implementation, a virtual prop giver does not need to manually select a quantity of virtual props to be given, but the terminal automatically determines the quantity of virtual props to be given according to a remaining prop quantity of virtual props owned by the second virtual object, and displays the quantity by using the prop transfer control, so that the user determines whether to trigger the prop transfer control.

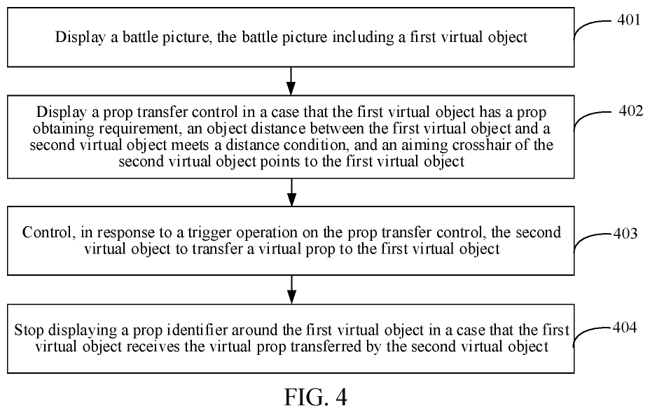

In an exemplary example, FIG. 4 is a flowchart of a virtual prop transfer method according to another exemplary embodiment of this application. This embodiment is described by using an example in which the method is applied to the first terminal 110 or the second terminal 130 in the implementation environment shown in FIG. 1 or another terminal in the implementation environment. The method includes the following steps.

Step 401: Display a battle picture, the battle picture including a first virtual object.

For an implementation of step 401, reference may be made to step 201, and details are not described again in this embodiment of this application.

Step 402: Display the prop transfer control when the first virtual object has the prop obtaining request, an object distance between the first virtual object and the second virtual object meets a distance condition, and the aiming crosshair of the second virtual object points to the first virtual object.

To enable other users in the same camp to know that the first virtual object has the prop obtaining request, in a possible implementation, after the first virtual object initiates a prop obtaining request, a prop identifier of a virtual prop (where the virtual prop is a virtual prop that the first virtual object needs to obtain) may be displayed around or near the first virtual object, where the prop identifier is used for representing that the first virtual object has the prop obtaining request, and the prop identifier may also be used for determining a virtual prop that the first virtual object needs to obtain, so that another user determines whether there is a prop identifier around or near the first virtual object, to determine whether the first virtual object has the prop obtaining request, and determine a virtual prop that needs to be obtained if the first virtual object has the prop obtaining request.

In some embodiments, when the first virtual object is located within a field of view of the second virtual object, the first virtual object may be displayed in a battle picture of the second virtual object, and a prop identifier is displayed around or near the first virtual object. The first virtual object being located within the field of view of the second virtual object may be that the object distance between the first virtual object and the second virtual object is less than or equal to a preset distance threshold, where the preset distance threshold may be 100 m.

In some embodiments, to prevent another user belonging to a hostile camp against the first virtual object from knowing a virtual prop that the first virtual object lacks, the prop identifier may be set to be visible only to another virtual object belonging to the same camp as the first virtual object.

In some embodiments, in other possible implementation, the prop identifier may alternatively be visible to a third virtual object (where the third virtual object is a virtual object belonging to a different camp from the first virtual object) under a specific condition. The specific condition may be that the third virtual object has a specific virtual prop, and when the first virtual object is located within a field of view of the third virtual object, the third virtual object may view a prop identifier displayed around or near the first virtual object, to know a virtual prop that the first virtual object lacks, where the specific virtual prop may be a virtual prop with a perspective function or a virtual prop with a remote viewing function, such as a telescope. Alternatively, the specific condition may be that when the third virtual object triggers or uses a specific object skill, and the first virtual object is located within a field of view of the third virtual object, the third virtual object may view a prop identifier displayed around or near the first virtual object. The specific object skill may be a remote observation skill, a perspective skill, or the like.

In some embodiments, a prop identifier displayed around or near the first virtual object can be viewed only when the first virtual object is located within a field of view of another virtual object. However, the field of view may be affected a virtual prop being used, for example, a virtual object using a telescope can view a farther field of view than a virtual object without a telescope. Therefore, in a possible implementation, virtual props currently held by the second virtual object are different, and the second virtual object determines that field of views are different when the first virtual object has a prop obtaining request.

To improve a success rate of transferring virtual props and avoid the influence of other obstacles between the first virtual object and the second virtual object on the aiming crosshair, in a possible implementation, when the object distance between the first virtual object and the second virtual object meets a distance condition, the second virtual object may become a virtual prop giver. Correspondingly, the prop transfer control is displayed when the first virtual object has the prop obtaining request, an object distance between the first virtual object and the second virtual object meets a distance condition, and the aiming crosshair of the second virtual object points to the first virtual object. Further, in a process of determining whether to display the prop transfer control, when the first virtual object has the prop obtaining request, the object distance between the first virtual object and the second virtual object may be first obtained, whether the object distance meets the distance condition may be further determined, and then a subsequent crosshair determining process is determined after the distance condition is met.

The distance condition may be that the object distance between the first virtual object and the second virtual object may be less than a distance threshold.

In a possible implementation, when the first virtual object has the prop obtaining request, the object distance between the first virtual object and the second virtual object may be obtained in real time. When it is determined that the object distance is less than the distance threshold, whether the aiming crosshair of the second virtual object points to the first virtual object is further determined. When the aiming crosshair points to the first virtual object, it is determined that the second virtual object that is mastered by the user has a need to transfer virtual props to the first virtual object, and the prop transfer control may be displayed.

The distance threshold may be set by a developer, for example, the distance threshold may be 1 m.

When whether the second virtual object may become a virtual prop giver is determined, whether the object distance between the second virtual object and the first virtual object meets a specific relationship needs to be determined, and the second virtual object may further need to have a specific quantity of virtual props, so that some virtual props may be transferred to the first virtual object. Correspondingly, in an exemplary example, step 402 may include step 402A and step 402B.

Step 402A: Obtain a remaining prop quantity of virtual props owned by the second virtual object when the first virtual object has the prop obtaining request, the object distance between the first virtual object and the second virtual object meets the distance condition, and the aiming crosshair of the second virtual object points to the first virtual object.

To determine whether the second virtual object has a capability of giving virtual props to the first virtual object, in a possible implementation, when it is determined that the object distance is less than the distance threshold (where the object distance meets the distance condition), and the aiming crosshair of the second virtual object points to the first virtual object, a remaining prop quantity of virtual props currently owned by the second virtual object needs to be obtained, to determine whether the second virtual object can become a virtual prop giver.

Step 402B: Display the prop transfer control when the remaining prop quantity is greater than a first quantity threshold.

The first quantity threshold may be set by the developer, for example, the first quantity threshold may be 1. In some embodiments, setting of the first quantity threshold may be determined according to a single use quantity of virtual props. The first quantity threshold may be 1 if the single use quantity is 1, and the first quantity threshold may be 3 if the single use quantity is 2. In other words, the remaining prop quantity needs to be at least twice the single use quantity, to ensure that after the second virtual object gives virtual props to the first virtual object, the second virtual object still has some virtual props, and a transfer quantity of virtual props transferred by the second virtual object to the first virtual object is at least sufficient for the first virtual object to use the virtual props once.

In a possible implementation, when it is determined that the remaining prop quantity is greater than the first quantity threshold, it indicates that the second virtual object has a capability of giving some virtual props to the first virtual object, and the prop transfer control may be displayed, to facilitate the user to perform a subsequent prop transfer operation. Otherwise, if the remaining prop quantity is less than the first quantity threshold, it indicates that the second virtual object does not have a capability of transferring some virtual props to the first virtual object, and the prop transfer control may not be displayed; and prompt information may be displayed, to prompt the user that a quantity of virtual props owned by the second virtual object is not sufficient, and a prop transfer operation cannot be performed.

In the related art, during virtual prop transfer, the virtual prop giver often needs to select to-be-transferred virtual props from a backpack, and select a quantity of to-be-transferred virtual props. The operation is relatively cumbersome. To further improve efficiency of transferring virtual props, in a possible implementation, the terminal may automatically determine, according to the remaining prop quantity of virtual props, a first transfer quantity of virtual props that need to be transferred to the first virtual object. Correspondingly, in an exemplary example, step 402B may include step 402b1 and step 402b2.

402b1: When the remaining prop quantity is greater than the first quantity threshold, determine, based on the remaining prop quantity, a first transfer quantity of virtual props transferred to the first virtual object.

In a possible implementation, when it is determined that the remaining prop quantity is greater than the first quantity threshold, it indicates that the second virtual object has a capability of transferring virtual props to the first virtual object. Further, the first transfer quantity of virtual props transferred to the first virtual object may be determined according to the remaining prop quantity.

When automatically determining the first transfer quantity, according to the remaining prop quantity, a prop quantity of virtual props transferable by the second virtual object, and a prop quantity of virtual props receivable by the first virtual object, the terminal may comprehensively consider the first transfer quantity of virtual props transferred to the first virtual object. Correspondingly, in an exemplary example, step 402b1 may include step 1 to step 3.

Step 1: Determine, based on the remaining prop quantity, a second transfer quantity of virtual props transferable by the second virtual object.

In a possible implementation, when obtaining the remaining prop quantity of the second virtual object, the second transfer quantity of virtual props transferable by the second virtual object may be determined according to the remaining prop quantity and a preset giving rule. In other words, a quantity of virtual props transferable by the second virtual object to the first virtual object may be first determined.

The preset giving rule may be set by the developer, for example, the preset giving rule may include: giving half of the remaining prop quantity; or giving ⅓ of the remaining prop quantity; or giving a specific quantity of the remaining prop quantity. The preset giving rule is not limited in the embodiments of this application.

In some embodiments, different preset giving rules may be set according to virtual props of different types. For example, for a virtual prop of a virtual medicine type, the preset giving rule is giving half of the remaining prop quantity; and for a virtual prop of a virtual ammunition type, the preset giving rule may be giving ⅓ of the remaining prop quantity.

In some embodiments, a giving rule for virtual props may further be determined according to the remaining prop quantity. Correspondingly, in an exemplary example, step 1 may further include step (1) and step (2).

Step (1): Determine a transfer quantity threshold of the virtual props as the second transfer quantity when the remaining prop quantity is greater than a third quantity threshold, different virtual props corresponding to different transfer quantity thresholds.

To avoid transferring more virtual props to the first virtual object, affecting game balance during the game, in a possible implementation, a third quantity threshold is set, where the third quantity threshold is a single maximum transferable quantity of the virtual props. When the remaining prop quantity is greater than the third quantity threshold, it indicates that the second virtual object has more virtual props, and the transfer quantity threshold of the virtual props is determined as the second transfer quantity. In other words, the transfer quantity threshold is a transfer quantity upper limit when the second virtual object transfers virtual props to the first virtual object.

In some embodiments, different transfer quantity thresholds may be set for virtual props of different types. For example, if the virtual props are virtual ammunition, a corresponding transfer quantity threshold may be 30

In some embodiments, the third quantity threshold may be set by the developer. Alternatively, different third quantity thresholds may be set according to virtual props of different types. For example, if the virtual props are virtual ammunition, a corresponding third quantity threshold may be 60.

Step (2): Determine, based on the remaining prop quantity and a transfer ratio, the second transfer quantity when the remaining prop quantity is less than or equal to the third quantity threshold.

In a possible implementation, when the remaining prop quantity is less than or equal to the third quantity threshold, it indicates that the remaining prop quantity is relatively small, and a prop quantity of the transfer ratio in the remaining prop quantity may be determined as the second transfer quantity.

The transfer ratio is a ratio of a maximum transferable remaining prop quantity, which may be ½ (determining ½ of the remaining prop quantity as the second transfer quantity), ⅓ (determining ⅓ of the remaining prop quantity as the second transfer quantity), ¼ (determining ¼ of the remaining prop quantity as the second transfer quantity), or the like. This is not limited in this embodiment of this application.

In some embodiments, a relationship between the third quantity threshold, the third quantity threshold, and the transfer ratio may be: third quantity threshold≥2*transfer quantity threshold≥2*remaining prop quantity*transfer ratio.

Step 2: Determine, when the second transfer quantity is greater than a second quantity threshold, the first transfer quantity based on the second quantity threshold, the second quantity threshold being determined based on a quantity of virtual props receivable by the first virtual object.

The process of determining the second transfer quantity according to the relationship between the remaining prop quantity and the third quantity threshold is used to determine a prop quantity of virtual props that the second virtual object can transfer to the first virtual object. After receiving virtual props transferred by the second virtual object, the first virtual object often needs to place the virtual props in the backpack, and a remaining capacity of the backpack may also affect the quantity of virtual props receivable by the first virtual object, affecting a quantity of props actually transferred by the second virtual object to the first virtual object. Therefore, to prevent the first virtual object from being unable to receive all transferred virtual props, in a possible implementation, when the first transfer quantity is determined, both the quantity of virtual props transferable by the second virtual object to the first virtual object and the quantity of virtual props receivable by the first virtual object need to be considered. Correspondingly, the terminal may obtain the quantity of virtual props receivable by the first virtual object, that is, the second quantity threshold, and determine a relationship between the second transfer quantity (the quantity of virtual props transferable by the second virtual object) and the second quantity threshold (the quantity of virtual props receivable by the first virtual object), and then determine, based on a relationship determination result, the first transfer quantity of virtual props actually transferred by the second virtual object to the first virtual object.

In some embodiments, when the second transfer quantity is greater than the second quantity threshold, it indicates that the quantity of props transferable by the second virtual object is greater than the quantity of props receivable by the first virtual object. To prevent the first virtual object being unable to receive all transferred virtual props, causing failure of virtual prop transfer, the second transfer quantity may be adjusted downward to a maximum quantity of props receivable by the first virtual object, that is, the second quantity threshold is determined as the first transfer quantity.

In an exemplary example, if a quantity of virtual ammunition transferable by the second virtual object is 30 (the second transfer quantity), and a quantity of virtual ammunition receivable by the first virtual object is 20 (the second quantity threshold), the first transfer quantity of virtual ammunition actually transferable by the second virtual object to the first virtual object is 20.

Step 3: Determine the second transfer quantity as the first transfer quantity when the second transfer quantity is less than or equal to the second quantity threshold.

In some embodiments, when the second transfer quantity is less than or equal to the second quantity threshold, it indicates that the quantity of props transferable by the second virtual object is less than or equal to the quantity of props receivable by the first virtual object, the first virtual object can receive all virtual props transferable by the second virtual object, and the second transfer quantity may be directly determined as the first transfer quantity.

In an exemplary example, if a quantity of virtual ammunition transferable by the second virtual object is 25 (the second transfer quantity), and a quantity of virtual ammunition receivable by the first virtual object is 30 (the second quantity threshold), the first transfer quantity of virtual ammunition actually transferable by the second virtual object to the first virtual object is 25.

In some embodiments, the second quantity threshold may also be determined according to a prop quantity of virtual props required by the first virtual object. For example, when the first virtual object requests transfer of virtual props, not only prop identifiers of the virtual props may be displayed around the first virtual object, but also a transfer quantity identifier of the virtual props may be displayed. The transfer quantity identifier is used for indicating a prop quantity of virtual props required by the first virtual object, that is, the prop quantity of virtual props receivable by the first virtual object. In some embodiments, when a prop quantity of virtual props that the first virtual object can carry is greater than a prop quantity indicated by the transfer quantity identifier, the prop quantity indicated by the transfer quantity identifier is determined as the second quantity threshold. If the prop quantity of virtual props that the first virtual object can carry is less than the prop quantity indicated by the transfer quantity identifier, it indicates that the first virtual object cannot receive all props even if the second virtual object transfers props of the prop quantity indicated by the transfer quantity identifier to the first virtual object, and the prop quantity of virtual props that the first virtual object can carry is determined as the second quantity threshold, to avoid waste of virtual props.

402b2: Display the first transfer quantity and the virtual props in the prop transfer control.

Since in this embodiment of this application, the first transfer quantity of virtual props is automatically determined by the terminal in a background according to the remaining prop quantity of the second virtual object, to enable the user to determine to allow transfer of virtual props of the first transfer quantity to the first virtual object, in a possible implementation, after the first transfer quantity is determined, when the prop transfer control is displayed, to-be-transferred virtual props and the first transfer quantity corresponding to the virtual props may be displayed in the prop transfer control, so that the user may determine whether to transfer.

In some embodiments, when a virtual prop is displayed in the prop transfer control, a prop name of the virtual prop may be displayed, and a prop icon style corresponding to the virtual prop may also be displayed, that is, the virtual prop to be transferred may be specified to the user. This is not limited in the embodiments of this application.

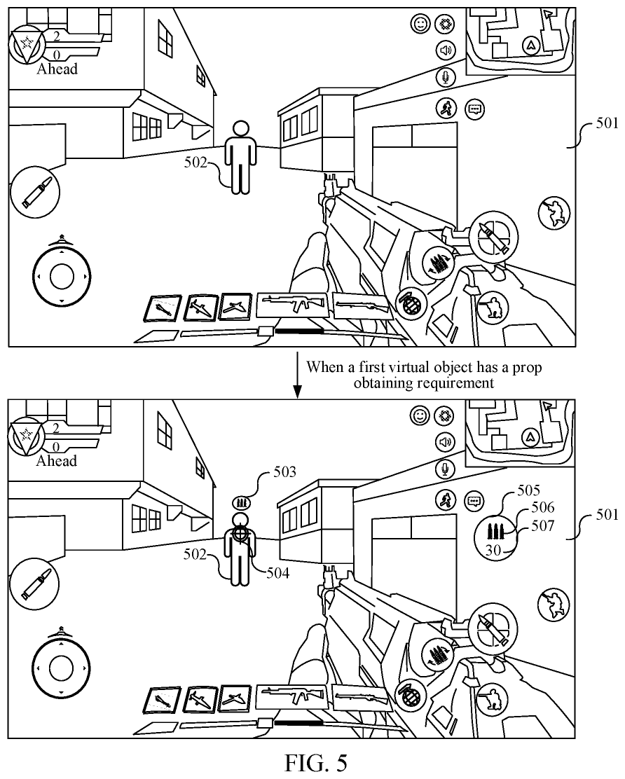

FIG. 5 is a schematic diagram of a virtual prop transfer process according to an exemplary embodiment of this application. A first virtual object 502 is displayed in a battle picture 501, and when the first virtual object 502 has a prop obtaining request, a prop identifier 503 is displayed around or near the first virtual object 502. When the user needs to transfer virtual props to the first virtual object 502, an aiming crosshair 504 may point to the first virtual object 502. Correspondingly, when the terminal determines that the aiming crosshair 504 points to the first virtual object 502, a prop transfer control 505 may be displayed in the battle picture 501. In addition, to-be-transferred virtual props 506 and a first transfer quantity 507 are displayed in the prop transfer control 505.

Since the prop transfer control is to realize transfer of virtual props, if before the prop transfer control is displayed, for example, when the user adjusts the aiming crosshair to point to the first virtual object, there may be a case in which the first virtual object has received virtual props transferred by another virtual object. To avoid repeated virtual prop transfer processes, in a possible implementation, before the prop transfer control is displayed, whether the first virtual object has received virtual props transferred by another virtual object further needs to be determined, and the prop transfer control is displayed when the first virtual object has not received virtual props transferred by another virtual object.

As can be seen from the above, if the second virtual object needs to become a virtual prop giver of the first virtual object, at least four conditions need to be met: The second virtual object has virtual props (where the remaining prop quantity is greater than the first quantity threshold), the object distance between the first virtual object and the second virtual object is less than the distance threshold, the first virtual object does not receive virtual props transferred by another virtual object, and the aiming crosshair of the second virtual object needs to point to the first virtual object.

During virtual prop transfer, there may be a case in which a prop quantity of virtual props transferred by the second virtual object to the first virtual object is less than the prop quantity of virtual props required by the first virtual object, that is, a single prop transfer operation cannot satisfy the prop quantity of virtual props required by the first virtual object. In some embodiments, each time the first virtual object initiates a prop obtaining request, it is set that only the first virtual object is allowed to receive virtual props transferred by another virtual object. In other words, if the first virtual object has received virtual props transferred by another virtual object once, regardless of whether a prop quantity of received virtual props meets a quantity of props required by the first virtual object (the prop quantity indicated by the transfer quantity identifier), display of the prop identifiers and the transfer quantity identifier around the first virtual object is stopped. In some embodiments, it is also possible to set the first virtual object to allow to receive, for several times, virtual props transferred by another virtual object each time the first virtual object initiates a prop obtaining request, that is, the first virtual object may receive virtual props transferred by a plurality of other virtual objects until the prop quantity of virtual props required by the first virtual object is met. For example, if the transfer quantity identifier displayed around the first virtual object indicates that the first virtual object needs 30 rounds of virtual ammunition, during the prop obtaining request, the first virtual object may receive 10 rounds of virtual ammunition transferred by a second virtual object A, and then may receive 20 rounds of virtual ammunition transferred by a second virtual object B. When the 30 rounds of virtual ammunition required by the first virtual object are met, display of the prop identifier and the transfer quantity identifier around the first virtual object is stopped, which indicates that the first virtual object does not have the prop obtaining request for the time being.

Step 403: Control, in response to a trigger operation on the prop transfer control, the second virtual object to transfer a virtual prop to the first virtual object.

In a possible implementation, to-be-transferred virtual props and a first transfer quantity needs to be transferred are displayed in the prop transfer control. If the user determines that the first transfer quantity meets the user's expectations, the prop transfer control may be clicked. Correspondingly, the terminal receives the trigger operation on the prop transfer control, and may control the second virtual object to transfer virtual props of the first transfer quantity to the first virtual object.

In some embodiments, after prop transfer is successful, for the second virtual object, the terminal reduces the virtual props of the first transfer quantity from the remaining prop quantity; and for the first virtual object, the terminal adds the virtual props of the first transfer quantity.

Step 404: Stop displaying the prop identifier around the first virtual object when the first virtual object receives the virtual prop transferred by the second virtual object.

Since the prop identifier displayed around or near the first virtual object is to remind teammates that the first virtual object has a prop obtaining request, to prevent the teammates from repeatedly transferring virtual props to the first virtual object, in a possible implementation, when the first virtual object receives virtual props transferred by the second virtual object, display of the prop identifier around or near the first virtual object may be stopped, to remind other teammates that the first virtual object has obtained a sufficient quantity of virtual props and does not have the prop obtaining request for the time being.

In some embodiments, after the first virtual object initiates a prop obtaining request, there may be a case in which another virtual object does not have corresponding virtual props and cannot transfer virtual props to the first virtual object. To avoid displaying the prop identifier around or near the virtual object for a long time, in a possible implementation, a display duration of the prop identifier is obtained in real time, and display of the prop identifier around or near the first virtual object is stopped when the display duration of the prop identifier is greater than a duration threshold.

In this embodiment, whether to display the prop transfer control is determined by determining whether the object distance between the first virtual object and the second virtual object meets a specific condition, whether the second virtual object has virtual props of a specific quantity, whether the second virtual object aims at the first virtual object, and whether the first virtual object receives virtual props transferred by another virtual object, to ensure a success rate of virtual prop transfer. In addition, the terminal automatically determines, in the background, the first transfer quantity of props that actually need to be transferred by the second virtual object to the first virtual object according to a remaining prop quantity of virtual props owned by the second virtual object, a quantity of virtual props transferable by the second virtual object, a quantity of virtual props receivable by the first virtual object, and the like. In this way, there is no need for the user to search the backpack and input a quantity of props that need to be transferred, and efficiency of virtual prop transfer is improved. In addition, the first transfer quantity that is automatically determined by the terminal can be received by the first virtual object, and the success rate of virtual prop transfer can be improved. In addition, the prop identifier and the transfer quantity identifier are displayed around the first virtual object, so that another virtual object may identify virtual props required by the first virtual object and a quantity of required virtual props, to further determine whether the another virtual object has a capability of giving virtual props, and avoid unnecessary giving actions having no capability for giving.

In other possible application scenarios, when initiating a prop obtaining request, the first virtual object may edit a quantity of virtual props that needs to obtain. Correspondingly, to remind the teammates of the quantity of required virtual props, in a possible implementation, not only the prop identifier is displayed around or near the first virtual object to remind a virtual prop that need to be obtained, but also the transfer quantity identifier corresponding to the virtual prop is displayed around or near the first virtual object. The transfer quantity identifier may represent a prop quantity of virtual props required by the first virtual object, so that other teammates may view the transfer quantity identifier, to determine, according to the transfer quantity identifier, the quantity of virtual props required by the first virtual object, and determine whether the teammates have a capability of transferring virtual props to the first virtual object.

In some embodiments, after the first virtual object initiates a prop obtaining request, in this prop request process, the first virtual object can only receive a single prop transfer, that is, after the first virtual object receives virtual props transferred by the second virtual object, display of the prop identifier and the transfer quantity identifier around or near the first virtual object is stopped. In other words, regardless of whether the first transfer quantity (the quantity of virtual props transferred by the second virtual object to the first virtual object) is the same as the prop quantity indicated by the transfer quantity identifier, a current prop request process is ended, and display of the prop identifier and the transfer quantity identifier around or near the first virtual object is stopped. If the first transfer quantity is less than the prop quantity indicated by the transfer quantity identifier, the first virtual object needs to re-initiate the prop obtaining request.

In some embodiments, in other possible implementations, after the first virtual object initiates the prop obtaining request, only after the first virtual object receives virtual props of a prop quantity indicated by the transfer quantity identifier, display of the prop identifier and the transfer quantity identifier around or near the first virtual object is stopped. In other words, only after the first virtual object receives the prop quantity indicated by the transfer quantity identifier, the current prop request process is ended.

In some embodiments, the process in which the first virtual object receives the virtual props of the prop quantity indicated by the transfer quantity identifier may be as follows: The second virtual object performs a prop transfer operation for N times to transfer the prop quantity indicated by the transfer quantity identifier to the first virtual object, N being a positive integer. When N is 1, it indicates that the first transfer quantity of the second virtual object to the first virtual object in a single transfer is greater than or equal to the prop quantity indicated by the transfer quantity identifier. When N is greater than 1, the second virtual object performs a prop transfer operation for several times to transfer the prop quantity indicated by the transfer quantity identifier to the first virtual object.

For the case where N is greater than 1, the same second virtual object may perform a prop transfer operation for several times to transfer the prop quantity indicated by the transfer quantity identifier to the first virtual object. Alternatively, different second virtual objects may perform a prop transfer operation for several times to transfer the prop quantity indicated by the transfer quantity identifier to the first virtual object.

In some embodiments, for the case where N is greater than 1, the transfer quantity identifier may be updated with a transfer quantity of virtual props that have been received by the first virtual object. The prop quantity indicated by the transfer quantity identifier=an initial prop quantity—a quantity of received props, where the initial prop quantity is a prop quantity of virtual props that need to be obtained by the first virtual object during this prop obtaining request.

In an exemplary example, when the first virtual object does not receive virtual props transferred by another virtual object, the transfer quantity identifier may be “30”; and when the first virtual object receives 20 virtual props transferred by the second virtual object, the transfer quantity identifier may change to “10” to promptly remind the teammates of a quantity of virtual props currently lacked by the first virtual object.

The first transfer quantity determined by the terminal in the background according to the preset giving rule is displayed in the prop transfer control. If the first transfer quantity meets the user's expectations, the user may realize one-click transfer by triggering the prop transfer control. If the first transfer quantity does not meet the user's expectations, to prevent the user from manually opening the backpack, selecting to-be-transferred virtual props, and selecting a transfer quantity, in a possible implementation, the user is allowed to directly modify the first transfer quantity displayed in the prop transfer control, to further improve prop transfer efficiency.

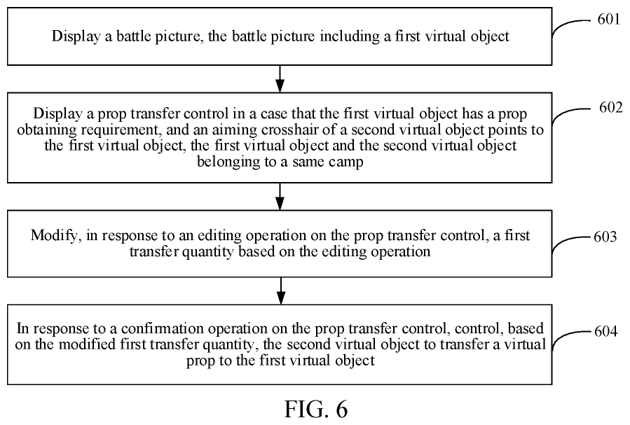

FIG. 6 is a flowchart of a virtual prop transfer method according to another exemplary embodiment of this application. This embodiment is described by using an example in which the method is applied to the first terminal 110 or the second terminal 130 in the implementation environment shown in FIG. 1 or another terminal in the implementation environment. The method includes the following steps.

Step 601: Display a battle picture, the battle picture including a first virtual object.

Step 602: Display a prop transfer control when the first virtual object has a prop obtaining request, and an aiming crosshair of a second virtual object points to the first virtual object, the first virtual object and the second virtual object belonging to a same camp.

In some embodiments, to-be-transferred virtual props and the first transfer quantity of virtual props are displayed in the prop transfer control, where the first transfer quantity is automatically determined by the terminal in the background based on the remaining prop quantity. For the process of determining the first transfer quantity according to the remaining prop quantity, reference may be made to the foregoing embodiments.

For implementations of step 601 and step 602, reference may be made to the foregoing embodiments, and details are not described again in this embodiment.

Step 603: Modify, in response to an editing operation on the prop transfer control, the first transfer quantity based on the editing operation.

To avoid a case in which the first transfer quantity displayed in the prop transfer control does not meet the user's expectations, in a possible implementation, the user is provided with an editing function for the first transfer quantity in the prop transfer control, so that when the user determines that the first transfer quantity displayed in the prop transfer control does not meet the user's expectations, the prop transfer control may be touched and held, and correspondingly, the terminal receives the editing operation on the prop transfer control, and sets the prop transfer control to be in an editable state. In this state, the user may edit the first transfer quantity, and correspondingly, the terminal determines the modified first transfer quantity based on the editing operation.

Step 604: In response to a confirmation operation on the prop transfer control, control, based on the modified first transfer quantity, the second virtual object to transfer the virtual prop to the first virtual object.

In some embodiments, after the user finishes modifying the first transfer quantity, the prop transfer control may be clicked, and correspondingly, the terminal receives the confirmation operation on the prop transfer control, and controls, based on the modified first transfer quantity, the second virtual object to transfer a virtual prop to the first virtual object.

In some embodiments, to prevent the user from unlimitedly transferring virtual props to the first object by using the second virtual object, after the user modifies the first transfer quantity, the terminal needs to verify the modified first transfer quantity. After verification on the first transfer quantity is successful, the user is allowed to transfer a virtual prop to the first virtual object by triggering the prop transfer control.

In some embodiments, verification on the first transfer quantity may be to verify whether the first transfer quantity is greater than a specific quantity threshold.

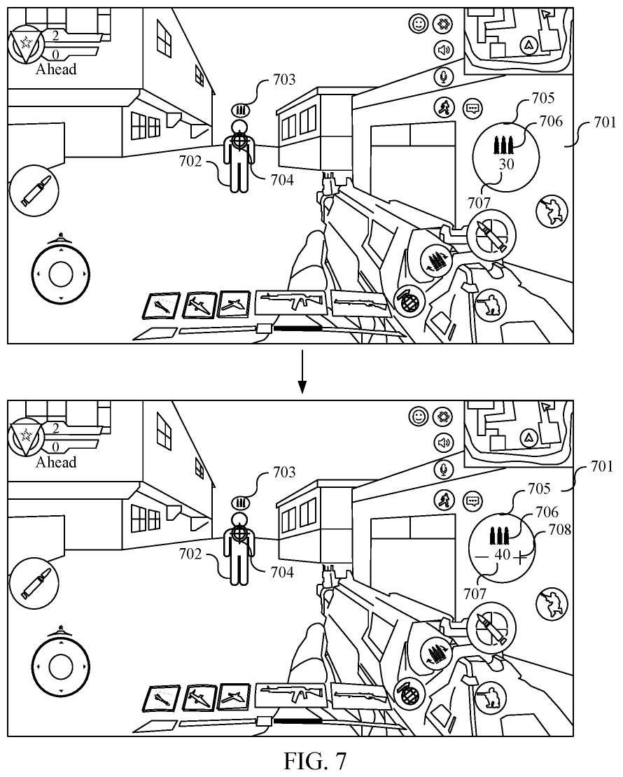

FIG. 7 is a schematic diagram of performing an editing operation on a prop transfer control according to an exemplary embodiment of this application. A first virtual object 702 is displayed in a battle picture 701, and when the first virtual object 702 has a prop obtaining request, a prop identifier 703 is displayed around or near the first virtual object 702. When the user needs to transfer virtual props to the first virtual object 702, an aiming crosshair 704 may point to the first virtual object 702. Correspondingly, when the terminal determines that the aiming crosshair 704 points to the first virtual object 702, a prop transfer control 705 may be displayed in the battle picture 701. In addition, to-be-transferred virtual props 706 and a first transfer quantity 707 are displayed in the prop transfer control 705. In some embodiments, when the user needs to modify the first transfer quantity 707, the user can touch and hold the prop transfer control 705, and correspondingly, the terminal receives a touch-and-hold operation on the prop transfer control 705, the prop transfer control 705 may enter an editing state, and an editing control 708 is correspondingly displayed, so that the user may modify the first transfer quantity 707 by performing a trigger operation on the editing control 708.

In this embodiment, by allowing the user to modify the first transfer quantity displayed in the prop transfer control, the first transfer quantity meets the user's requirements. In this case, the user may avoid the process of manually selecting virtual props and a transfer quantity from the backpack, thereby further improving prop transfer efficiency.

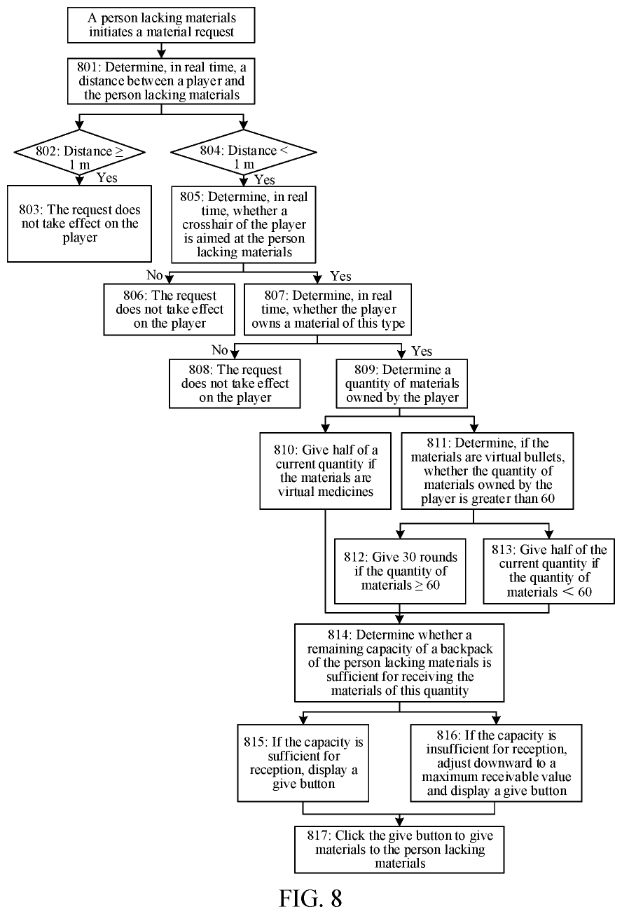

FIG. 8 is a flowchart of performing virtual prop transfer by a virtual prop giver according to an exemplary embodiment of this application. The virtual prop giver corresponds to the second virtual object in the foregoing embodiments. The process includes the following steps.

Step 801: Determine, in real time, a distance between a player and a person lacking materials.

When the person lacking materials initiates a material request, the distance between the player and the person lacking materials is first determined. In some embodiments, when the person lacking materials initiates a material request, all other players belonging to the same camp may receive material request information.

Step 802: Distance≥1 m.

When the distance between the player (corresponding to the second virtual object in the foregoing embodiments) and the person lacking materials (corresponding to the first virtual object in the foregoing embodiments) is greater than 1 m, the request does not take effect for the player, that is, the second virtual object cannot transfer virtual props to the first virtual object.

Step 803: The request does not take effect for the player.

Step 804: Distance<1 m.

When the distance between the player and the person lacking materials is less than 1 meter, whether a crosshair (an aiming crosshair) of the player is aimed at the person lacking materials is continued to be determined, and if the crosshair is aimed at the person lacking materials, step 807 is performed, to continue to determine whether the player owns a material of this type.

Step 805: Determine, in real time, whether the crosshair of the player is aimed at the person lacking materials.

Step 806: The request does not take effect for the player.

If the aiming crosshair of the second virtual object is not aimed at the first virtual object, the second virtual object cannot transfer virtual props to the first virtual object.

Step 807: Determine, in real time, whether the player owns a material of this type.

If the player owns the material of this type, a quantity of materials that need to be transferred is continued to be determined.

Step 808: The request does not take effect for the player.

If the second virtual object does not have the material, the second virtual object cannot transfer the material or virtual prop to the first virtual object.

Step 809: Determine a quantity of materials owned by the player.

Step 810: Give half of a current quantity if the materials are virtual medicines.

If virtual props requested by the first virtual object are virtual medicines, the second virtual object is set to give the first virtual object with half of the remaining prop quantity of virtual props. The remaining prop quantity is a quantity of virtual props currently owned by the second virtual object.

Step 811: Determine, if the materials are virtual bullets, whether the quantity of materials owned by the player is greater than 60.

Step 812: Give 30 rounds if the quantity of materials≥60.

If virtual props requested by the first virtual object are virtual bullets, whether a remaining prop quantity of virtual bullets owned by the second virtual object is greater than rounds is continued to be determined. If the quantity is greater than 60 rounds, the second virtual object is set to give 30 rounds of virtual bullets to the first virtual object.

Step 813: Give half of the current quantity if the quantity of materials<60.

If the remaining prop quantity of virtual bullets owned by the second virtual object is less than 60 rounds, the second virtual object is set to give the first virtual object with half of the remaining prop quantity of virtual bullets.

Step 814: Determine whether a remaining capacity of a backpack of the person lacking materials is sufficient for receiving the materials of this quantity.

Step 815: If the capacity is sufficient for reception, display a give button.

Step 816: If the capacity is insufficient for reception, adjust downward to a maximum receivable value and display a give button.

If the remaining capacity of the backpack of the first virtual object can receive virtual props of the quantity, a give button (the prop transfer control) is displayed, and prop transfer is performed by triggering the prop transfer control. If the remaining capacity of the backpack of the first virtual object is insufficient to receive virtual props of the quantity, the quantity is adjusted downward to a maximum receivable quantity, and a give button is displayed.

Step 817: Click the give button to give materials to the person lacking materials.

The foregoing embodiments mainly describe the process of how to control the second virtual object to transfer virtual props to the first virtual object. Compared with the virtual prop transfer process in the related art, in the virtual prop transfer method provided in the embodiments of this application, prop transfer efficiency of the virtual prop giver is improved, and there is no need for the virtual prop receiver to pick up virtual props. This embodiment mainly describes how the virtual prop receiver (which is the first virtual object in the foregoing embodiments) initiates the prop obtaining request.

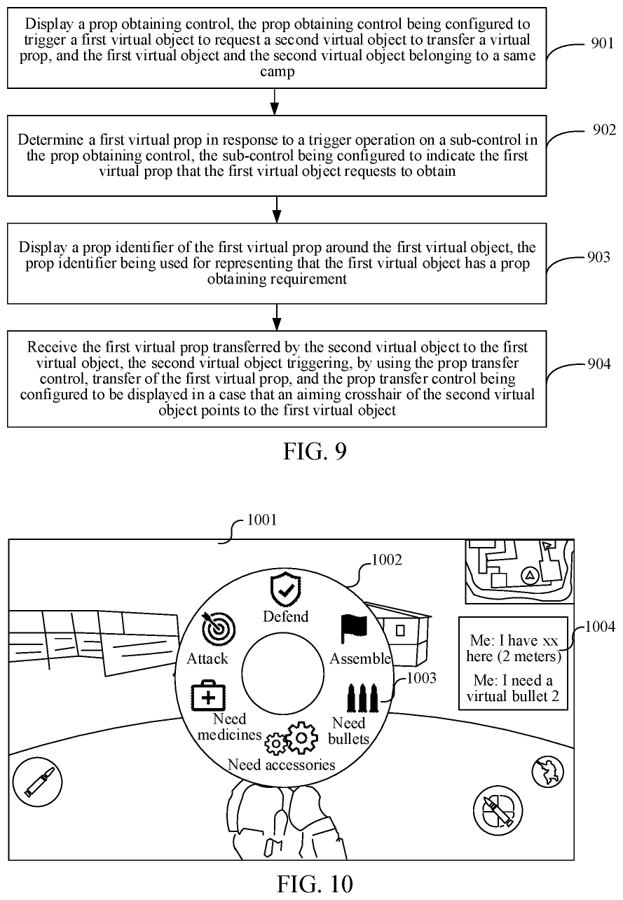

FIG. 9 is a flowchart of a virtual prop transfer method according to an exemplary embodiment of this application. This embodiment is described by using an example in which the method is applied to the first terminal 110 or the second terminal 130 in the implementation environment shown in FIG. 1 or another terminal in the implementation environment. The method includes the following steps.

Step 901: Display a prop obtaining control, the prop obtaining control being configured to trigger a first virtual object to request a second virtual object to transfer a virtual prop, and the first virtual object and the second virtual object belonging to a same camp.

In a possible implementation, the user may call out the prop obtaining control, and perform a trigger operation on the prop obtaining control, to trigger the first virtual object (which is a virtual object that is mastered by the user) to request the second virtual object to transfer virtual props. In addition, the second virtual object is a virtual object belonging to the same camp as the first virtual object.

For example, the prop obtaining control may be a virtual wheel.

FIG. 10 is a schematic diagram of a process of initiating a prop obtaining request according to an exemplary embodiment of this application. The first virtual object is displayed in a battle picture 1001 (which is a battle picture under a third-person perspective). When the user who masters the first virtual object has a prop obtaining request, the user may call out a prop obtaining control 1002. The prop obtaining control 1002 includes a plurality of sub-controls. When the user has a need for obtaining virtual bullets, the user may click a sub-control 1003, and correspondingly, the terminal receives a trigger operation on the sub-control 1003, may determine, according to a prop type (a virtual bullet) indicated by the sub-control 1003, a first virtual prop (a virtual bullet 2) that needs to be requested, and indicate a prop obtaining request to obtaining the virtual bullet 2. Correspondingly, a target message (where the virtual bullet 2 is required) may be displayed in a chat channel 1004.

Step 902: Determine a first virtual prop in response to a trigger operation on a sub-control in the prop obtaining control, the sub-control being configured to indicate the first virtual prop that the first virtual object requests to obtain.

Since there are various types of virtual props, to facilitate the user to quickly initiate a required prop obtaining request by using the prop obtaining control, in a possible implementation, the prop obtaining control includes a plurality of sub-controls, and different sub-controls may indicate different virtual props. The user triggers different sub-controls to select the first virtual prop that the first virtual object requests to obtain, and correspondingly, the terminal receives the trigger operation on the sub-controls in the prop obtaining control, and may determine, based on the sub-control, the first virtual prop that the first virtual object needs to request to obtain.

For example, if the sub-control is configured to instruct to obtain virtual ammunition, the corresponding first virtual prop is virtual ammunition.

In some embodiments, after obtaining the first virtual prop requested by the first virtual object, the terminal may send a target message requesting to obtain the first virtual prop to the chat channel, and in this case, another terminal where the second virtual object is located may receive and display the target message.

The first virtual prop in this embodiment is equivalent to the virtual prop in the foregoing embodiments, and both indicate the virtual prop that the first virtual object requests to transfer to another virtual object.

Step 903: Display a prop identifier of the first virtual prop around the first virtual object, the prop identifier being used for representing that the first virtual object has a prop obtaining request.

To remind teammates that the first virtual object has a prop obtaining request, in a possible implementation, a prop identifier of the first virtual prop may also be displayed around or near the first virtual object, so that other users may intuitively determine that the first virtual prop has the prop obtaining request and determine the first virtual object that needs to be obtained.

In some embodiments, the prop identifier may be a prop name corresponding to the first virtual prop, or a prop icon corresponding to the first virtual prop, or other identifiers that can uniquely identify the first virtual prop. This is not limited in the embodiments of this application.

In some embodiments, for a display position of the prop identifier around or near the first virtual object, the prop identifier may be displayed on the head of the first virtual object, or on a left side or right side of the first virtual object.

In some embodiments, if the first virtual object has a requirement for obtaining various virtual props at the same time, prop identifiers of different virtual props may be respectively displayed in different positions around the first virtual object. Correspondingly, when transferring virtual props to the first virtual object, the second virtual object may determine, according to a position pointed by the aiming crosshair, virtual props to be transferred to the first virtual object. For example, if the first virtual object has a requirement for obtaining virtual ammunition and virtual medicines at the same time, a first prop identifier of the virtual ammunition may be displayed on the head of the first virtual object, and a second prop identifier of the virtual medicines may be displayed on a left side of the first virtual object. Correspondingly, if the second virtual object transfers virtual ammunition to the first virtual object, conditions that need to be met include: The object distance between the second virtual object and the first virtual object meets the distance condition, and the aiming crosshair of the second virtual object points to a head region position of the first virtual object, the second virtual object owns virtual ammunition of a specific quantity, and the first virtual object has not received virtual ammunition transferred by another virtual object. The prop transfer control may be displayed only when the foregoing conditions are met, so that the prop transfer control may be triggered to transfer virtual ammunition by the second virtual object to the first virtual object. If the second virtual object needs to transfer virtual medicines to the first virtual object, conditions that need to be met include: The object distance between the second virtual object and the first virtual object meets the distance condition, and the aiming crosshair of the second virtual object points to a left body position of the first virtual object, the second virtual object owns virtual medicines of a specific quantity, and the first virtual object has not received virtual medicines transferred by another virtual object. The prop transfer control may be displayed only when the foregoing conditions are met, so that the prop transfer control may be triggered to transfer virtual medicines by the second virtual object to the first virtual object.

In some embodiments, in other possible implementations, if the first virtual object has a requirement for obtaining various virtual props at the same time, the aiming crosshair of the second virtual object points to the first virtual object (regardless of whether the crosshair points to which body position of the first virtual object), the object distance between the second virtual object and the first virtual object meets the distance condition, the second virtual object has a capability of transferring a variety of virtual props, and the first virtual object has not received virtual props transferred by another virtual object, to distinguish between transfer operations on different virtual props, a plurality of prop transfer controls may be displayed, different prop transfer controls are configured to transfer different virtual props.

In some embodiments, if the current battle picture is under a first-person perspective, the first virtual object may not be displayed in the battle picture, nor may the prop identifier be displayed. If the battle picture is under a third-person perspective, the first virtual object and the prop identifier may be displayed in the battle picture.

Step 904: Receive the first virtual prop transferred by the second virtual object to the first virtual object, the second virtual object triggering, by using the prop transfer control, transfer of the first virtual prop, and the prop transfer control being configured to be displayed when an aiming crosshair of the second virtual object points to the first virtual object.

In a possible implementation, when the user who masters the second virtual object knows that the first virtual object has a prop obtaining request, the virtual prop transfer method shown in the foregoing embodiments may be used to transfer the first virtual prop to the first virtual object, and correspondingly, the terminal receives the first virtual prop transferred by the second virtual object to the first virtual object. Since the user can transfer the first virtual prop to the first virtual object with one click through the prop transfer control, correspondingly, the first virtual object does not need to move to a target location to perform a prop pickup operation, which can also improve efficiency of receiving the first virtual prop by the first virtual object.

For the process of transferring the first virtual prop by the second virtual object to the first virtual object, reference may be made to the foregoing embodiments, and details are not described in this embodiment.

In some embodiments, when the first virtual object receives the first virtual prop transferred by the second virtual object, it is set to stop displaying the prop identifier around or near the first virtual object, which can prevent another virtual object from repeating the prop transfer process.

In some embodiments, after the prop identifier is displayed around or near the first virtual object, a display duration of the prop identifier may also be obtained, and when the display duration of the prop identifier is greater than a duration threshold, it is set to stop displaying the prop identifier around or near the first virtual object.

Based on the above, in this embodiment of this application, when the first virtual object initiates a prop obtaining request, the prop identifier may be displayed around or near the first virtual object, to remind other users that the first virtual object has a prop obtaining request, and prevent the prop obtaining request from being ignored by other users due to display only in text, which further improves a success rate of virtual prop transfer. In addition, there is no need to control the first virtual object to move to a specific location to pick up the virtual prop, the virtual prop transferred by the second virtual object may be directly received, and efficiency of receiving the virtual prop by the first virtual object may be further improved.

In a possible application scenario, the sub-control may only indicate a prop type of the virtual prop that needs to be requested, but cannot indicate a specific first virtual prop. To determine the first virtual prop that meets the current user's expectations, the first virtual prop may be determined according to a preset prop request rule with reference to the selected prop type.

In an exemplary example, step 902 may include step 902A to step 902C.

Step 902A: Determine, in response to the trigger operation on the sub-control in the prop obtaining control, a prop type indicated by the sub-control.

The sub-control is only configured to indicate a prop type, for example, the sub-control is configured to indicate virtual ammunition. In a possible implementation, after the terminal receives the trigger operation on the sub-control in the prop obtaining control, the prop type indicated by the sub-control may be determined based on a relationship between the sub-control and the prop type.

Step 902B: Determine, based on the prop type, at least one second virtual prop belonging to the prop type.

By using an example in which the prop type is virtual ammunition, different types of virtual ammunition are configured for different virtual props in the game. Therefore, to more accurately determine the first virtual prop that needs to be requested by the first virtual object, in a possible implementation, after the terminal determines the prop type according to the sub-control, the first virtual prop further needs to be determined from a plurality of second virtual props corresponding to the prop type.

Step 902C: Determine the first virtual prop from the second virtual props based on a prop priority of each of the second virtual props.

In some embodiments, in a prop transfer scenario, a prop priority of each second virtual prop is set, and the prop priority indicates an order for requesting the second virtual props. By using an example in which the prop type is virtual ammunition, there are five types of virtual ammunition, and the prop priority is: virtual ammunition 1>virtual ammunition 3>virtual ammunition 4>virtual ammunition 2>virtual ammunition 5. As can be seen from the prop priority that, the virtual ammunition 1 is requested first.

In a possible implementation, the terminal may determine the second virtual prop with the highest prop priority as the first virtual prop based on each second virtual prop corresponding to the prop type and the prop priority.

Since virtual props have an upper limit for picking up during the battle, when a prop obtaining request is initiated, after the second virtual prop with the highest prop priority is determined, it is also necessary to consider whether a quantity of existing props corresponding to the second virtual prop reaches a pickup upper limit, and if the pickup upper limit is reached, the candidate virtual prop cannot be requested. Correspondingly, in an exemplary example, step 902C may further include step 1 to step 3.

Step 1: Determine a second virtual prop with a highest prop priority.

Step 2: Determine a quantity of existing props of the second virtual prop.

In a possible implementation, based on the prop priority of each second virtual prop, the second virtual prop with the highest prop priority is determined, and then the quantity of existing props corresponding to the second virtual prop is further determined, to determine whether the quantity of existing props has reached the pickup upper limit.

Step 3: Determine the second virtual prop as the first virtual prop when the quantity of existing props is less than a fourth quantity threshold.

In some embodiments, when the quantity of existing props corresponding to the second virtual prop with the highest prop priority is less than the fourth quantity threshold, it indicates that the second virtual prop has not reached the pickup upper limit, and the second virtual prop may be requested to obtain, and correspondingly, the second virtual prop is determined as the first virtual prop.

In some embodiments, when the quantity of existing props corresponding to the second virtual prop with the highest prop priority is greater than or equal to the fourth quantity threshold, it indicates that the second virtual prop has reached the pickup upper limit, and the request for obtaining the second virtual prop cannot be continued. In this case, according to the prop priority, a second virtual prop of a next lower level is selected to determine between the quantity of existing props and the fourth quantity threshold, and if the quantity has not reached the pickup upper limit, the second virtual prop of the next lower level may be determined as the first virtual prop.

In another possible implementation, the first virtual prop that needs to be obtained may also be determined based on a virtual prop currently used by the first virtual object. In another exemplary example, step 902 may further include step 902D to step 902F.

Step 902D: Obtain, in response to the trigger operation on the sub-control in the prop obtaining control, a held virtual prop being used by the first virtual object and a prop type indicated by the sub-control.

By using an example in which the prop type is virtual ammunition, the user may prefer to request virtual ammunition required by the currently held virtual prop. Therefore, in a possible implementation, when the terminal receives the trigger operation on the sub-control in the prop obtaining control, the held virtual prop being used by the first virtual object and the prop type indicated by the sub-control may be obtained, so that the first virtual prop is determined from the second virtual props based on the held virtual prop.

Step 902E: Determine at least one second virtual prop belonging to the prop type.

Step 902F: Determine, when the second virtual prop includes a virtual prop required during use of the held virtual prop, the second virtual prop required during use of the held virtual prop as the first virtual prop.

In a possible implementation, when the second virtual prop includes a virtual prop required during use of the held virtual prop, it may indicate that the user prefers to request a virtual prop that need to be used for the held virtual props, and then second virtual prop required during use of the held virtual prop may be determined as the first virtual prop.

In an exemplary example, if the prop type is virtual ammunition, and the prop type includes five types of virtual ammunition, the held virtual prop being used by the first virtual object needs to use virtual ammunition 3, and correspondingly, the virtual ammunition 3 is determined as the first virtual prop.

In some embodiments, to further improve accuracy of the requested first virtual prop, the user may also manually select the virtual prop that needs to be requested. In another exemplary example, step 902 may further include step 902G and step 902H.

Step 902G: Display, in response to a touch-and-hold operation on the sub-control in the prop obtaining control, at least one second virtual prop belonging to a prop type, the prop type being a prop type indicated by the sub-control.

In a possible implementation, each second virtual prop may be displayed in a user interface, so that the user may manually select the first virtual prop that needs to request to another virtual object to transfer. Correspondingly, after receiving the touch-and-hold operation on the sub-control in the prop obtaining control, the terminal may display at least one second virtual prop corresponding to the prop type around or near the prop obtaining control.

In some embodiments, when a plurality of second virtual props are displayed, only prop names or prop icons corresponding to the second virtual props may be displayed.

Step 902H: Determine the first virtual prop in response to a selection operation on the second virtual prop.

In some embodiments, after receiving the selection operation on the second virtual prop, the terminal may determine a second virtual prop indicated by the selection operation as the first virtual prop.

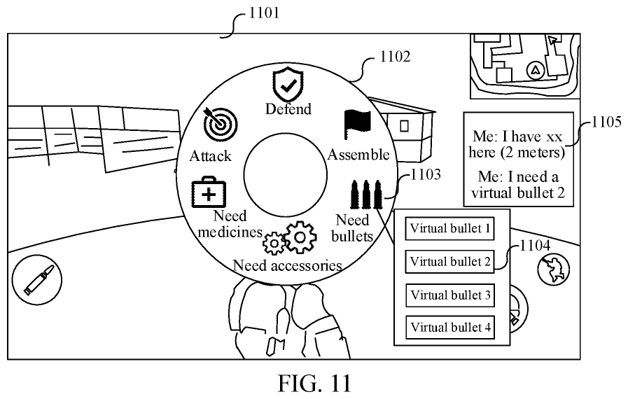

FIG. 11 is a schematic diagram of a process of selecting a first virtual prop according to an exemplary embodiment of this application. The first virtual object is displayed in a battle picture 1101 (which is a battle picture under a third-person perspective). When the user who masters the first virtual object has a prop obtaining request, the user may call out a prop obtaining control 1102. The prop obtaining control 1102 includes a plurality of sub-controls. When the user has a requirement for obtaining virtual bullets, the user may touch and hold a sub-control 1103, and correspondingly, the terminal receives a trigger operation on the sub-control 1103, and displays a plurality of second virtual props 1104 around or near the prop obtaining control 1102. If the terminal receives a trigger operation on the second virtual prop 1104, the second virtual prop (the virtual bullet 2) is determined as the first virtual prop, and correspondingly, a prop obtaining request for the virtual bullet 2 is initiated, and a target message is displayed in a chat channel 1105 message (where the virtual bullet 2 is required).

In some embodiments, in other possible implementations, according to parameters such as historical use frequency, historical request obtaining frequency, a preset prop priority, and a quantity of existing props of each second virtual prop corresponding to the prop type, the terminal may further comprehensively analyze a first virtual prop that the user is currently prefer to obtain.

In an exemplary example, step 902 may further include step 902I to step 902L.

Step 902I: In response to the trigger operation on the sub-control in the prop obtaining control, determine, based on the prop type indicated by the sub-control, at least one second virtual prop belonging to the prop type.

For an implementation of step 902I, reference may be made to the foregoing embodiments, and details are not described again in this embodiment.

Step 902J: Obtain virtual prop parameters of each second virtual prop, the virtual prop parameters include the historical use frequency, the historical request obtaining frequency, the preset prop priority, and the quantity of existing props of the second virtual prop.

To make the first virtual prop selected by the terminal more in line with the user's expectations, the first virtual prop that users prefer to choose may be analyzed in comprehensive consideration of virtual prop parameters corresponding to virtual props, such as historical use frequency (where the user may be more inclined to obtain a second virtual prop with higher historical usage frequency), historical request obtaining frequency (where a second virtual prop frequently requested by the user during the battle may be analyzed according to the virtual props obtained through user's historical requests), a preset prop priority, and a quantity of existing props (where the user may be more inclined to obtain a second virtual props with a quantity of existing props).

Step 902K: Determine a prop selection score of each second virtual prop based on the virtual prop parameters and parameter weights of the virtual prop parameters.

To comprehensively analyze the parameters of each virtual prop, since the parameters of each virtual prop are not on a same order of magnitude, in a possible implementation, parameter weights may be set for each virtual prop parameter, and correspondingly, the prop selection score of each second virtual prop is determined based on the virtual prop parameters and the parameter weights of the virtual prop parameters, where a higher prop selection score indicates that the user is more inclined to select the second virtual prop.

Step 902L: Determine a second virtual prop with a highest prop selection score as the first virtual prop.

In a possible implementation, the second virtual prop with the highest prop selection score is determined as the first virtual prop.

In some embodiments, if the second virtual prop with the highest prop selection score has reached the prop pickup upper limit, then whether a second virtual prop with a prop selection score of a next lower level has reached the prop pickup upper limit is continued to be determined. If the prop pickup upper limit is not reached, the second virtual prop with a prop selection score of a next lower level is determined as the first virtual prop.

In this embodiment, a plurality of manners of selecting the first virtual prop are provided. The first virtual prop is determined based on the prop priority or the held virtual prop, so that the selected first virtual prop is more consistent with a virtual prop currently required by the first virtual object, and there is no need for the user to control the first virtual object to manually select virtual props that need to be requested, which can improve prop selection efficiency. In addition, by displaying the second virtual prop and allowing the user to manually select, prop selection accuracy may be improved.

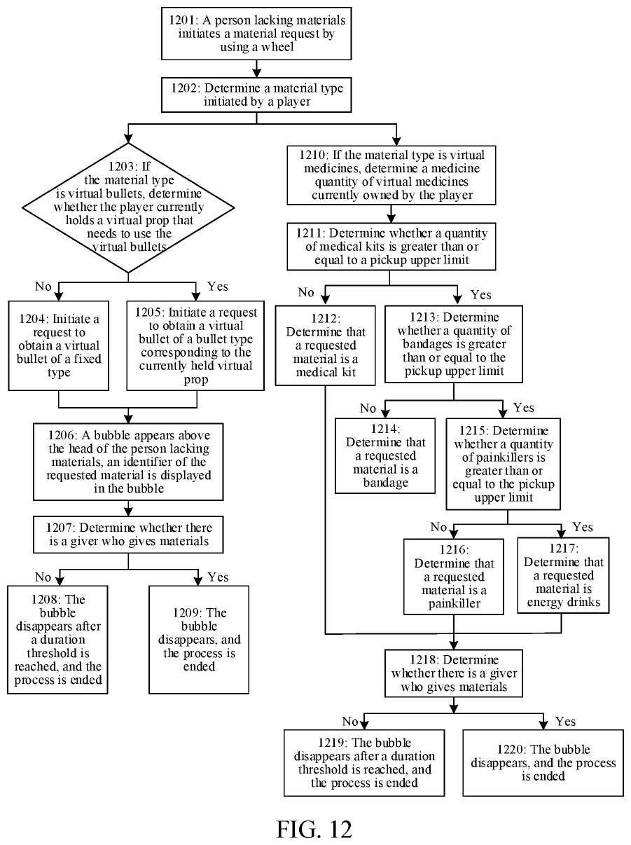

FIG. 12 is a flowchart of performing virtual prop transfer by a person lacking virtual props according to an exemplary embodiment of this application. The person lacking virtual props corresponds to the first virtual object in the foregoing embodiments. The process includes the following steps.

Step 1201: A person lacking materials initiates a material request by using a wheel.

The first virtual object initiates a material request by using a virtual wheel (the prop obtaining control).

Step 1202: Determine a material type initiated by a player.

The material type initiated by the player is determined by performing a trigger operation by the person lacking materials on the wheel.

Step 1203: If the material type is virtual bullets, determine whether the player currently holds a virtual prop that needs to use the virtual bullets.

Exemplary descriptions are made by using an example in which two kinds of requested virtual props are virtual bullets and virtual medicines.

Step 1204: Initiate a request to obtain a virtual bullet of a fixed type.

Step 1205: Initiate a request to obtain a virtual bullet of a bullet type corresponding to the currently held virtual prop.

Step 1206: A bubble appears above the head of the person lacking materials, an identifier of the requested material is displayed in the bubble.

If the first virtual object requests virtual bullets, whether the first virtual object holds a virtual prop and needs to consume virtual bullets to perform an attack operation is continued to be performed. If the first virtual object holds the virtual prop, a prop obtaining request for the virtual bullet required by the currently held prop is preferentially initiated. Conversely, if the first virtual object does not currently hold the virtual prop, a prop obtaining request for a default virtual bullet is initiated.

Step 1207: Determine whether there is a giver who gives materials.

Step 1208: The bubble disappears after a duration threshold is reached, and the process is ended.

Step 1209: The bubble disappears, and the process is ended.

Step 1210: If the material type is virtual medicines, determine a medicine quantity of virtual medicines currently owned by the player.

Step 1211: Determine whether a quantity of medical kits is greater than or equal to a pickup upper limit.

Step 1212: Determine that a requested material is a medical kit.

Step 1213: Determine whether a quantity of bandages is greater than or equal to the pickup upper limit.

Step 1214: Determine that a requested material is a bandage.

Step 1215: Determine whether a quantity of painkillers is greater than or equal to the pickup upper limit.

Step 1216: Determine that a requested material is a painkiller.

Step 1217: Determine that a requested material is energy drinks.

If the first virtual object requests virtual medicines, since there is an upper limit for picking up virtual medicines, it is necessary to obtain a quantity of virtual medicines currently owned by the first virtual object. Whether a quantity of medical kits is greater than or equal to the pickup upper limit is preferentially determined, and if the quantity is less than the pickup upper limit, a prop obtaining request for the medical kit may be directly initiated. If the quantity is greater than or equal to the pickup upper limit, whether a quantity of bandages is greater than or equal to the pickup upper limit is continued to be determined. If the quantity is less than the pickup upper limit, a prop obtaining request for the bandages is directly initiated. If the quantity is greater than or equal to the pickup upper limit, whether a quantity of painkillers is greater than or equal to the pickup upper limit is continued to be determined. If the quantity is less than the pickup upper limit, a prop obtaining request for the painkillers is initiated. If the quantity is greater than or equal to the pickup upper limit, a prop obtaining request for the energy drinks is initiated.

Step 1218: Determine whether there is a giver who gives materials.

Step 1219: The bubble disappears after a duration threshold is reached, and the process is ended.

Step 1220: The bubble disappears, and the process is ended.

FIG. 13 is a structural block diagram of virtual prop transfer apparatus according to an exemplary embodiment of this application. The apparatus includes:
a display module 1301, configured to display a battle picture, the battle picture including a first virtual object, where
the display module 1301 is further configured to display a prop transfer control when the first virtual object has a prop obtaining request, and an aiming crosshair of a second virtual object points to the first virtual object, the first virtual object and the second virtual object belonging to a same camp; and
a control module 1302, configured to control, in response to a trigger operation on the prop transfer control, the second virtual object to transfer a virtual prop to the first virtual object.

In some embodiments, the display module 1301 is further configured to:
display the prop transfer control when the first virtual object has the prop obtaining request, an object distance between the first virtual object and the second virtual object meets a distance condition, and the aiming crosshair of the second virtual object points to the first virtual object.

In some embodiments, the display module 1301 is further configured to:
obtain a remaining prop quantity of virtual props owned by the second virtual object when the first virtual object has the prop obtaining request, the object distance between the first virtual object and the second virtual object meets the distance condition, and the aiming crosshair of the second virtual object points to the first virtual object; and
display the prop transfer control when the remaining prop quantity is greater than a first quantity threshold.

In some embodiments, the display module 1301 is further configured to:
when the remaining prop quantity is greater than the first quantity threshold, determine, based on the remaining prop quantity, a first transfer quantity of virtual props transferred to the first virtual object; and
display the first transfer quantity and the virtual props in the prop transfer control.

In some embodiments, the display module 1301 is further configured to:
determine, based on the remaining prop quantity, a second transfer quantity of virtual props transferable by the second virtual object;
determine, when the second transfer quantity is greater than a second quantity threshold, the first transfer quantity based on the second quantity threshold, the second quantity threshold being determined based on a quantity of virtual props receivable by the first virtual object; and
determine the second transfer quantity as the first transfer quantity when the second transfer quantity is less than or equal to the second quantity threshold.

In some embodiments, the display module 1301 is further configured to:
determine a transfer quantity threshold of the virtual props as the second transfer quantity when the remaining prop quantity is greater than a third quantity threshold, different virtual props corresponding to different transfer quantity thresholds; and
determine, based on the remaining prop quantity and a transfer ratio, the second transfer quantity when the remaining prop quantity is less than or equal to the third quantity threshold.

In some embodiments, the display module 1301 is further configured to:
obtain the object distance between the first virtual object and the second virtual object when the first virtual object has the prop obtaining request; and
display the prop transfer control when the object distance is less than a distance threshold, and the aiming crosshair of the second virtual object points to the first virtual object.

In some embodiments, the display module 1301 is further configured to display a prop identifier of the virtual prop around the first virtual object, the prop identifier being used for representing that the first virtual object has a prop obtaining request.

In some embodiments, the apparatus further includes:
a display stop module, configured to stop displaying the prop identifier around the first virtual object when the first virtual object receives the virtual prop transferred by the second virtual object.

In some embodiments, the apparatus further includes:
a display stop module, further configured to stop displaying the prop identifier around the first virtual object when a display duration of the prop identifier is greater than a duration threshold.

In some embodiments, the display module 1301 is further configured to:
display a transfer quantity identifier of the virtual prop around the first virtual object, the transfer quantity identifier being used for representing a prop quantity of virtual props required by the first virtual object, and the transfer quantity identifier being updated with a transfer quantity of virtual props that have been received by the first virtual object.

In some embodiments, the display module 1301 is further configured to:
display the prop transfer control when the first virtual object does not receive the virtual prop transferred by another virtual object.

In some embodiments, to-be-transferred virtual props and the first transfer quantity of virtual props are displayed in the prop transfer control.

The apparatus further includes:
an editing module, configured to modify, in response to an editing operation on the prop transfer control, the first transfer quantity based on the editing operation.

The control module 1302 is further configured to:
in response to a confirmation operation on the prop transfer control, control, based on the modified first transfer quantity, the second virtual object to transfer the virtual prop to the first virtual object.

Based on the above, in the embodiments of this application, a method for transferring virtual props between virtual objects in a battle is provided. After a first virtual object requests for virtual props, second virtual objects belonging to a same camp may aim at the first virtual object, and click a prop transfer control, so that the virtual props are transferred to the first virtual object. Compared with the related art that requires several steps such as opening a backpack, selecting exchange materials, discarding and marking materials, and picking up materials, the virtual prop transfer method provided in this application can greatly simplify operation steps of transferring virtual props and reduce operation costs for virtual prop transfer, thereby improving efficiency of transferring the virtual props. In addition, a virtual prop giver (virtual prop transfer party) can realize one-click transfer of virtual props by triggering a prop transfer control, so that prop giving costs of the virtual prop giver may be reduced, thereby improving frequency of using a virtual prop transfer function in a battle while promoting more users to control virtual objects to become virtual prop givers and enhancing communication with teammates.

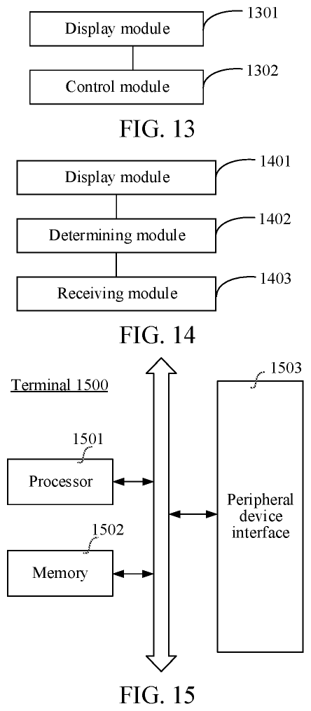

FIG. 14 is a structural block diagram of virtual prop transfer apparatus according to another exemplary embodiment of this application. The apparatus includes:
a display module 1401, configured to display a prop obtaining control, the prop obtaining control being configured to trigger a first virtual object to request a second virtual object to transfer a virtual prop, and the first virtual object and the second virtual object belonging to a same camp;
a determining module 1402, configured to determine a first virtual prop in response to a trigger operation on a sub-control in the prop obtaining control, the sub-control being configured to indicate the first virtual prop that the first virtual object requests to obtain, where
the display module 1401 is further configured to display a prop identifier of the virtual prop around the first virtual object, the prop identifier being used for representing that the first virtual object has the prop obtaining request; and
a receiving module 1403, configured to receive the first virtual prop transferred by the second virtual object to the first virtual object, the second virtual object triggering, by using the prop transfer control, transfer of the first virtual prop, and the prop transfer control being configured to be displayed when an aiming crosshair of the second virtual object points to the first virtual object.

In some embodiments, the determining module 1402 is further configured to:
determine, in response to the trigger operation on the sub-control in the prop obtaining control, a prop type indicated by the sub-control;
determine, based on the prop type, at least one second virtual prop belonging to the prop type; and
determine the first virtual prop from the second virtual props based on a prop priority of each of the second virtual props.

In some embodiments, the determining module 1402 is further configured to:
determine a second virtual prop with a highest prop priority;
determine a quantity of existing props of the second virtual prop; and
determine the second virtual prop as the first virtual prop when the quantity of existing props is less than a fourth quantity threshold.

In some embodiments, the determining module 1402 is further configured to:
obtain, in response to the trigger operation on the sub-control in the prop obtaining control, a held virtual prop being used by the first virtual object and a prop type indicated by the sub-control;
determine at least one second virtual prop belonging to the prop type; and
determine, when the second virtual props include a virtual prop required during use of the held virtual prop, the second virtual prop required during use of the held virtual prop as the first virtual prop.

In some embodiments, the determining module 1402 is further configured to:
display, in response to a touch-and-hold operation on the sub-control in the prop obtaining control, at least one second virtual prop belonging to a prop type, the prop type being a prop type indicated by the sub-control; and
determine the first virtual prop in response to a selection operation on the second virtual prop.

In some embodiments, the display module 1401 is further configured to stop displaying the prop identifier around the first virtual object when the first virtual object receives the first virtual prop transferred by the second virtual object.

In some embodiments, the display module 1401 is further configured to stop displaying the prop identifier around the first virtual object when a display duration of the prop identifier is greater than a duration threshold.

Based on the above, in this embodiment of this application, when the first virtual object initiates a prop obtaining request, the prop identifier may be displayed around the first virtual object, to remind other users that the first virtual object has a prop obtaining request, and prevent the prop obtaining request from being ignored by other users due to display only in text, which further improves a success rate of virtual prop transfer. In addition, there is no need to control the first virtual object to move to a specific location to pick up the virtual prop, the virtual prop transferred by the second virtual object may be directly received, and efficiency of receiving the virtual prop by the first virtual object may be further improved.

FIG. 15 is a structural block diagram of a terminal 1500 according to an exemplary embodiment of this application. The device 1500 may be a portable mobile terminal such as a smartphone, a tablet computer, an MP3 player, or an MP4 player. The terminal 1500 may be further referred to as other names such as user equipment and a portable terminal.

Generally, the terminal 1500 includes a processor 1501 and a memory 1502.

The processor 1501 may include one or more processing cores, for example, a 4-core processor or an 8-core processor. The processor 1501 may be implemented by using at least one hardware form of a digital signal processor (DSP), a field-programmable gate array (FPGA), and a programmable logic array (PLA). The processor 1501 may alternatively include a main processor and a coprocessor. The main processor is a processor configured to process data in an active state, also referred to as a central processing unit (CPU). The coprocessor is a low-power processor configured to process data in a standby state. In some embodiments, the processor 1501 may be integrated with a graphics processing unit (GPU). The GPU is configured to render and draw content that needs to be displayed on a display screen. In some embodiments, the processor 1501 may further include an artificial intelligence (AI) processor. The AI processor is configured to process a computing operation related to machine learning.

The memory 1502 may include one or more computer-readable storage media. The computer-readable storage medium may be tangible and non-transient. The memory 1502 may further include a high-speed random access memory (RAM), and a non-volatile memory such as one or more magnetic disk storage devices and a flash storage device. In some embodiments, a non-transitory computer-readable storage medium in the memory 1502 is configured to store at least one instruction, the at least one instruction being configured to be executed by the processor 1501 to implement the virtual prop transfer method provided in the embodiments of this application.

In some embodiments, the terminal 1500 may include a peripheral interface 1503 and at least one peripheral. Specifically, the peripheral device includes: at least one of a radio frequency circuit, a touch display screen, a camera component, an audio circuit, and a power supply.

A person skilled in the art may understand that the structure shown in FIG. 15 constitutes no limitation on the terminal 1500, and the terminal may include more or fewer components than those shown in the figure, or some components may be combined, or a different component deployment may be used.

An embodiment of this application further provides a computer-readable storage medium, storing at least one program, the at least one program being loaded and executed by a processor to implement the virtual prop transfer method described in the foregoing embodiments.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. An aspect of this application provides a computer program product, including computer instructions, the computer instructions being stored in a computer-readable storage medium. A processor of a terminal reads the computer instructions from the computer-readable storage medium, and executes the computer instructions, to cause the terminal to perform the virtual prop transfer method in the implementations of the foregoing aspect.

What is claimed is:

1. A virtual prop transfer method, performed by a computer device, the method comprising:
displaying a battle picture, the battle picture comprising a first virtual object;
determining that the first virtual object has a prop obtaining request followed by an aiming crosshair of a second virtual object pointing to the first virtual object, the first virtual object and the second virtual object belonging to a same camp;
displaying a prop transfer control in response to the aiming crosshair of the second virtual object pointing to the first virtual object; and
in response to a trigger operation on the prop transfer control, controlling the second virtual object to transfer a virtual prop to the first virtual object according to the prop obtaining request.

2. The method according to claim 1, wherein the displaying a prop transfer control in response to the aiming crosshair of the second virtual object pointing to the first virtual object comprises:
displaying the prop transfer control when an object distance between the first virtual object and the second virtual object meets a distance condition.

3. The method according to claim 2, wherein the displaying the prop transfer control when an object distance between the first virtual object and the second virtual object meets a distance condition comprises:
obtaining a remaining prop quantity of virtual props owned by the second virtual object; and
displaying the prop transfer control when the remaining prop quantity is greater than a first quantity threshold.

4. The method according to claim 3, wherein the displaying the prop transfer control when the remaining prop quantity is greater than a first quantity threshold comprises:
when the remaining prop quantity is greater than the first quantity threshold, determining a first transfer quantity of virtual props transferred to the first virtual object; and
displaying the first transfer quantity and the virtual props in the prop transfer control.

5. The method according to claim 4, wherein the determining a first transfer quantity of virtual props transferred to the first virtual object comprises:
determining a second transfer quantity of virtual props transferable by the second virtual object;
when the second transfer quantity is greater than a second quantity threshold, determining the first transfer quantity based on a quantity of virtual props receivable by the first virtual object; and
when the second transfer quantity is less than or equal to the second quantity threshold, determining the second transfer quantity as the first transfer quantity.

6. The method according to claim 2, wherein the displaying the prop transfer control when an object distance between the first virtual object and the second virtual object meets a distance condition comprises:
obtaining the object distance between the first virtual object and the second virtual object in response to the prop obtaining request; and
displaying the prop transfer control when the object distance is less than a distance threshold.

7. The method according to claim 1, further comprising:
displaying a prop identifier of the virtual prop around the first virtual object, the prop identifier representing that the first virtual object has the prop obtaining request.

8. The method according to claim 7, further comprising:
stopping displaying the prop identifier around the first virtual object when the first virtual object receives the virtual prop transferred by the second virtual object.

9. The method according to claim 7, further comprising:
stopping displaying the prop identifier around the first virtual object when a display duration of the prop identifier is greater than a duration threshold.

10. The method according to claim 1, further comprising:
displaying a transfer quantity identifier of the virtual prop around the first virtual object before the first virtual object receives a virtual prop, the transfer quantity identifier representing a prop quantity of virtual props required by the first virtual object; and
updating the transfer quantity identifier with a transfer quantity of virtual props that have been received by the first virtual object.

11. A computer device, comprising a processor and a memory, the memory storing at least one program, the at least one program being loaded and executed by the processor and causing the computer device to implement a virtual prop transfer method including:
displaying a battle picture, the battle picture comprising a first virtual object;
determining that the first virtual object has a prop obtaining request followed by an aiming crosshair of a second virtual object pointing to the first virtual object, the first virtual object and the second virtual object belonging to a same camp;
displaying a prop transfer control in response to the aiming crosshair of the second virtual object pointing to the first virtual object; and
in response to a trigger operation on the prop transfer control, controlling the second virtual object to transfer a virtual prop to the first virtual object according to the prop obtaining request.

12. The computer device according to claim 11, wherein the displaying a prop transfer control in response to the aiming crosshair of the second virtual object pointing to the first virtual object comprises:
displaying the prop transfer control when an object distance between the first virtual object and the second virtual object meets a distance condition.

13. The computer device according to claim 12, wherein the displaying the prop transfer control when an object distance between the first virtual object and the second virtual object meets a distance condition comprises:
obtaining a remaining prop quantity of virtual props owned by the second virtual object; and
displaying the prop transfer control when the remaining prop quantity is greater than a first quantity threshold.

14. The computer device according to claim 13, wherein the displaying the prop transfer control when the remaining prop quantity is greater than a first quantity threshold comprises:
when the remaining prop quantity is greater than the first quantity threshold, determining a first transfer quantity of virtual props transferred to the first virtual object; and
displaying the first transfer quantity and the virtual props in the prop transfer control.

15. The computer device according to claim 12, wherein the displaying the prop transfer control when an object distance between the first virtual object and the second virtual object meets a distance condition comprises:
obtaining the object distance between the first virtual object and the second virtual object in response to the prop obtaining request; and
displaying the prop transfer control when the object distance is less than a distance threshold.

16. The computer device according to claim 11, wherein the method further comprises:
displaying a prop identifier of the virtual prop around the first virtual object, the prop identifier representing that the first virtual object has the prop obtaining request.

17. The computer device according to claim 11, wherein the method further comprises:
displaying a transfer quantity identifier of the virtual prop around the first virtual object before the first virtual object receives a virtual prop, the transfer quantity identifier representing a prop quantity of virtual props required by the first virtual object; and
updating the transfer quantity identifier with a transfer quantity of virtual props that have been received by the first virtual object.

18. A non-transitory computer-readable storage medium, storing at least one program, the at least one program being loaded and executed by a processor of a computer device and causing the computer device to implement a virtual prop transfer method including:
displaying a battle picture, the battle picture comprising a first virtual object;
determining that the first virtual object has a prop obtaining request followed by an aiming crosshair of a second virtual object pointing to the first virtual object, the first virtual object and the second virtual object belonging to a same camp;
displaying a prop transfer control in response to the aiming crosshair of the second virtual object pointing to the first virtual object; and
in response to a trigger operation on the prop transfer control, controlling the second virtual object to transfer a virtual prop to the first virtual object according to the prop obtaining request.

19. The non-transitory computer-readable storage medium according to claim 18, wherein the displaying a prop transfer control in response to the aiming crosshair of the second virtual object pointing to the first virtual object comprises:
displaying the prop transfer control when an object distance between the first virtual object and the second virtual object meets a distance condition.

20. The non-transitory computer-readable storage medium according to claim 18, wherein the method further comprises:
displaying a transfer quantity identifier of the virtual prop around the first virtual object before the first virtual object receives a virtual prop, the transfer quantity identifier representing a prop quantity of virtual props required by the first virtual object; and
updating the transfer quantity identifier with a transfer quantity of virtual props that have been received by the first virtual object.
